(19) United States
(12) Patent Application Publication
(10) Pub. No.: US 2024/0323749 A1
(43) Pub. Date: Sep. 26, 2024

(54) INFORMATION INDICATION METHOD FOR P2P LINK AND RELATED APPARATUS

(71) Applicant: HUAWEI TECHNOLOGIES CO., LTD., Shenzhen (CN)

(72) Inventors: Yunbo LI, Shenzhen (CN); Yuchen GUO, Shenzhen (CN); Ming GAN, Shenzhen (CN); Guogang HUANG, Shenzhen (CN)

(21) Appl. No.: 18/672,133

(22) Filed: May 23, 2024

Related U.S. Application Data
(63) Continuation of application No. PCT/CN2022/127662, filed on Oct. 26, 2022.

(30) Foreign Application Priority Data
Nov. 24, 2021 (CN) 202111407040.4

(51) Int. Cl. H04W 28/02; H04W 28/08

(52) U.S. Cl. CPC H04W 28/0268; H04W 28/0875; H04W 28/095

(57) ABSTRACT

The present disclosure relates to the field of wireless communication, is applied to a wireless local area network supporting the 802.11 series standards, for example, the 802.11be (EHT) standard, and particularly relates to an information indication method for a P2P link and a related apparatus. The method includes: A STA/non-AP MLD sends a QoS characteristics element to an AP/AP MLD, where the QoS characteristics element carries first indication information indicating a physical layer rate of a P2P link, and a direction subfield in the QoS characteristics element indicates that a data direction is the P2P link. According to embodiments of the present disclosure, an AP side may reuse uplink and downlink time allocation algorithms.

### CROSS-REFERENCE TO RELATED APPLICATIONS

This application is a continuation of International Application No. PCT/CN2022/127662, filed on Oct. 26, 2022, which claims priority to Chinese Patent Application No. 202111407040.4, filed on Nov. 24, 2021. The disclosures of the aforementioned applications are hereby incorporated by reference in their entireties.

### TECHNICAL FIELD

The present disclosure relates to the field of wireless communication technologies, and in particular, to an information indication method for a peer-to-peer (P2P) link and a related apparatus.

### BACKGROUND

A continuous technical goal of development and evolution of a wireless local area network (WLAN) or a cellular network is to continuously improve a throughput. WLAN system protocols are mainly discussed and studied by the institute of electrical and electronics engineers (IEEE) standard group. In the previous standard protocols such as the 802.11a/b/g/n/ac/ax, the throughput is continuously improved. The next-generation standard 802.11be is referred to as an extremely high throughput (EHT) standard, Wi-Fi 7, or the like, and takes significantly improving a peak throughput as a most important technical goal.

Low latency or latency sensitivity is an important characteristic of the 802.11be standard. When a station (STA) supports a service with a latency-sensitive characteristic, the characteristic of the service may be reported to an access point (AP) associated with the station (STA), to request the AP to allocate a time resource to meet a transmission requirement of the service. The station may perform peer-to-peer (P2P) transmission of the service with another station on the allocated time resource, or send uplink data of the service to the AP. A P2P link used for P2P transmission is set up by two non-access point stations (non-AP STAs) through tunneled direct link setup (TDLS) or according to another P2P protocol. In some scenarios, P2P may also be referred to as device-to-device (D2D), TDLS, or the like. P2P, D2D, TDLS, and the like are essentially the same.

Currently, how a station reports information on the P2P link has not been resolved.

### SUMMARY

Embodiments of the present disclosure provide an information indication method for a P2P link and a related apparatus. A physical layer parameter (for example, a physical layer rate, a modulation and coding scheme, or a number of spatial streams) of the P2P link may be reported through a quality of service (QOS) characteristics element. Therefore, when receiving a characteristic of a service on the P2P link, an AP side may reuse uplink and downlink time allocation algorithms. Further, the present disclosure further provides a technical solution for extending a P2P link to a multi-link, to improve transmission efficiency/a throughput.

The following describes the present disclosure from different aspects. It should be understood that the following implementations and beneficial effects of the different aspects may be mutually referenced.

According to a first aspect, the present disclosure provides an information indication method for a P2P link. The method includes: A first device generates and sends a QoS characteristics element. The QoS characteristics element includes a control information field and first indication information. The control information field includes a direction subfield. The direction subfield is set to 2 (that is, a first value is 2 in decimal system), to indicate that a data direction described by the QoS characteristics element is a P2P link. The first indication information (directly or indirectly) indicates a physical layer rate of the P2P link. The P2P link is short for data transmission on the P2P link, that is, data (for example, a medium access control (MAC) service data unit (MSDU) or an aggregated MSDU) is sent from one non-access point station device to another non-access point station device. Herein, the non-access point station device may be a STA, or may be a non-AP multi-link device (non-AP MLD). In other words, the data direction is that the data is sent from one STA to another STA, or the data is sent from one non-AP MLD to another non-AP MLD.

The first device in the present disclosure is a STA (single-link) or a non-AP MLD. The QoS characteristics element in the present disclosure is merely an example, and the name should not be used as a limitation on a function of the QoS characteristics element. With progress of the standard, there may be another name.

For a downlink service and an uplink service, because an AP can learn of a rate (particularly depending on parameters such as a modulation and coding scheme, a number of spatial streams, and a bandwidth) reachable by a physical layer link, the AP may obtain, through calculation with reference to the rate of the physical layer link, transmission time that needs to be allocated to a service reported by a station. On the P2P link, a station communicates with another station, and the AP cannot obtain information about the physical layer rate of the P2P link. Therefore, in the solution, the first indication information is carried in the QOS characteristics element to indicate the physical layer rate of the P2P link, so that the AP can obtain, through calculation based on the physical layer rate, transmission time required by a service reported on the P2P link, and further, an AP side can reuse uplink and downlink time allocation algorithms.

According to a second aspect, the present disclosure provides an information indication method for a P2P link. The method includes: A second device receives and parses a QoS characteristics element. The QoS characteristics element includes a control information field and first indication information. The control information field includes a direction subfield. The direction subfield is set to 2 (that is, a first value is 2 in decimal system), to indicate that a data direction described by the QoS characteristics element is a P2P link. The first indication information (directly or indirectly) indicates a physical layer rate of the P2P link. The P2P link is short for data transmission on the P2P link, that is, data (for example, an MSDU or an aggregated MSDU) is sent from one non-access point station device to another non-access point station device. Herein, the non-access point station device may be a STA, or may be a non-AP MLD. In other words, the data direction is that the data is sent from one STA to another STA, or the data is sent from one non-AP MLD to another non-AP MLD.

The second device in the present disclosure is an AP (single-link) or an AP MLD.

With reference to the second aspect, in a possible implementation, the method further includes: The second device determines, based on an indication of the first indication information, a time resource allocated to a service on the P2P link. For a specific allocation manner, refer to uplink and downlink time allocation algorithms.

Optionally, the first indication information includes one or more of the following: a physical layer rate, a modulation and coding scheme (MCS), and a number of spatial streams (NSS). The second device determines the physical layer rate based on an MCS value and the NSS when the first indication information is the MCS and the NSS, and determines, based on the determined physical layer rate, the time resource allocated to the service on the P2P link.

According to a third aspect, the present disclosure provides a communication apparatus. The communication apparatus may be a first device or a chip in the first device, for example, a Wi-Fi chip. The communication apparatus includes: a processing unit, configured to generate a QoS characteristics element, where the QoS characteristics element includes a control information field and first indication information, the control information field includes a direction subfield, the direction subfield is set to a first value, to indicate that a data direction described by the QoS characteristics element is a P2P link, the P2P link is that an MSDU or an aggregated MSDU is sent from one non-access point station device to another non-access point station device, and the first indication information indicates a physical layer rate of the P2P link; and a transceiver unit, configured to send the QoS characteristics element.

According to a fourth aspect, the present disclosure provides a communication apparatus. The communication apparatus may be a second device or a chip in the second device, for example, a Wi-Fi chip. The communication apparatus includes: a transceiver unit, configured to receive a QoS characteristics element; and a parsing unit, configured to parse the QoS characteristics element, where the QoS characteristics element includes a control information field and first indication information, the control information field includes a direction subfield, the direction subfield is set to a first value, to indicate that a data direction described by the QoS characteristics element is a peer-to-peer (P2P) link, the P2P link is that an MSDU or an aggregated MSDU is sent from one non-access point station device to another non-access point station device, and the first indication information indicates a physical layer rate of the P2P link.

With reference to the fourth aspect, in a possible implementation, the communication apparatus further includes: a determining unit, configured to determine, based on an indication of the first indication information, a time resource allocated to a service on the P2P link.

Optionally, the first indication information includes one or more of the following: a physical layer rate, an MCS, and an NSS. The determining unit is specifically configured to: determine the physical layer rate based on an MCS value and the NSS when the first indication information is the MCS and the NSS; and determine, based on the determined physical layer rate, the time resource allocated to the service on the P2P link.

The parsing unit and the determining unit may be integrated into one unit, for example, a processing unit.

In a possible implementation of any one of the foregoing aspects, the first indication information includes one or more of the following: the physical layer rate, the modulation and coding scheme (MCS), and the number of spatial streams (NSS). When the first indication information is the physical layer rate of the P2P link, the first indication information directly indicates the physical layer rate of the P2P link. When the first indication information is the MCS and the NSS of the P2P link, the first indication information indirectly indicates the physical layer rate of the P2P link. This is because the MCS and NSS are main parameters that affect the physical layer rate.

Optionally, the first indication information may further include another parameter that may be used to determine the physical layer rate, for example, a padding length or a cyclic prefix (CP) length.

In the solution, the physical layer rate is directly reported on a station side, so that the AP side can obtain a more accurate physical layer rate. This is because the station side learns of physical layer parameters of a P2P link set up between the station side and another device, such as an MCS, an NSS, a bandwidth, a padding length, and a CP length. These physical layer parameters may be used to calculate the physical layer rate. In the solution, the main parameters, namely, the MCS and the NSS, used for determining the physical layer rate may also be reported on the station side, so that the AP side determines the physical layer rate based on the MCS and the NSS, to reduce complexity on the station side.

In a possible implementation of any one of the foregoing aspects, the QoS characteristics element may be carried in a stream classification service (SCS) request frame.

In a possible implementation of any one of the foregoing aspects, when the first device is the non-AP MLD, a P2P service may be transmitted on a multi-link (ML). Therefore, a physical layer rate of each link needs to be indicated. Therefore, the QoS characteristics element further includes second indication information, and the second indication information indicates that at least one of multiple links is used as the P2P link described by the QoS characteristics element. In other words, the second indication information indicates at least one link to which the P2P link described by the QoS characteristics element in multiple links is mapped. If the second indication information indicates that n links in the multiple links are used as P2P links described by the QoS characteristics element, the QoS characteristics element includes n pieces of first indication information and n bandwidth fields. n is a positive integer. One piece of first indication information indicates a physical layer rate of one of the n links, and one bandwidth field indicates a maximum bandwidth for transmission on one of the n links.

Optionally, the second indication information may be present in a form of a bitmap, and one bit of the second indication information corresponds to one link. When one bit of the second indication information is set to a second value (for example, 1), it indicates that a link corresponding to the bit is used as the P2P link described by the QoS characteristics element, or indicates that the P2P link described by the QoS characteristics element is mapped to a link corresponding to the bit.

In the solution, the P2P link is extended to multi-link devices (MLDs), and a corresponding physical layer rate indication manner is designed. In this way, the AP side can reuse the uplink and downlink time allocation algorithms. In addition, advantages of the multi-link can be used, to improve transmission efficiency/a throughput of the P2P service and further reduce latency.

In a possible implementation of any one of the foregoing aspects, the QoS characteristics element further includes third indication information, and the third indication information indicates a mean service interval allocated to the first device for frame exchange on the P2P link. Alternatively, the third indication information indicates an average length of two consecutive service intervals allocated to the first device for frame exchange on the P2P link. In other words, the third indication information indicates an interval at which the time resource is allocated to the first device once.

In the solution, the third indication information is added to the QoS characteristics element to indicate the mean service interval allocated to the first device for frame exchange on the P2P link, so as to refine a time resource allocation manner.

In a possible implementation of any one of the foregoing aspects, the QoS characteristics element further includes fifth indication information, and the fifth indication information indicates a P2P link to which a traffic flow (or a P2P service) described by the QoS characteristics element is mapped.

Because a station may set up P2P links with a plurality of other stations separately, when the station reports a characteristic of a P2P service to an AP associated with the station, the AP cannot learn of a P2P link that the reported service is for. Therefore, in the solution, the fifth indication information is introduced into the QoS characteristics element, to indicate a P2P link that the traffic flow described by the QoS characteristics element is for, so that the AP side can distinguish between P2P services reported by the station side, thereby avoiding causing confusion to the AP side.

In a possible implementation of any one of the foregoing aspects, the control information field further includes a traffic identifier (TID) subfield. A TID value indicated by the TID subfield is different from a TID value corresponding to any service on a P2P link set up between the first device and another device. In other words, when establishing a service, the first device allocates a unique TID to any service on a plurality of P2P links. Alternatively, a TID value indicated by the TID subfield is different from a TID value corresponding to a traffic flow on a P2P link that is historically reported by the first device based on the QoS characteristics element. In other words, the first device allocates a unique TID to a service that needs to be reported. A TID corresponding to a service that does not need to be reported may be reused on different P2P links.

In the solution, it is restricted that a P2P service has a unique TID, or that a P2P service that needs to be reported has a unique TID. In this way, the AP side does not receive a plurality of P2P services that have a same TID and that are reported by a same station. To be specific, when reporting P2P services, the station does not use a same TID for services on different P2P links, thereby avoiding causing confusion to the AP side.

According to a fifth aspect, the present disclosure provides an information indication method for a P2P link. The method includes: A first device generates and sends a QoS characteristics element. The QoS characteristics element includes a control information field, third indication information, and fourth indication information. The control information field includes a direction subfield. The direction subfield is set to 2 (that is, a first value is 2 in decimal system), to indicate that a data direction described by the QoS characteristics element is a P2P link. The third indication information indicates a mean service interval allocated to the first device for frame exchange on the P2P link. In other words, the third indication information indicates an interval at which a time resource is allocated to the first device once. The fourth indication information indicates medium time that is required by each mean service interval for transmission on the P2P link and that is requested by the first device. In other words, the fourth indication information indicates a size of a time resource allocated to the first device each time.

The P2P link is short for data transmission on the P2P link, that is, data (for example, an MSD or an aggregated MSDU) is sent from one non-access point station device to another non-access point station device. Herein, the non-access point station device may be a STA, or may be a non-AP MLD. In other words, the data direction is that the data is sent from one STA to another STA, or the data is sent from one non-AP MLD to another non-AP MLD.

The first device in the present disclosure is a STA (single-link) or a non-AP MLD.

The QoS characteristics element includes a medium time field for the P2P service, and the field is a time length that a station requests an AP to allocate to the station in each second. It provides a total time length required in each second, but does not provide how to allocate time resources, for example, a number of parts into which the time resources are divided, and a length of each time resource. Therefore, in the solution, medium time in the QoS characteristics element is changed from the total time length required in each second to a time length required by each mean service interval, and the third indication information is added to indicate an average length of service intervals. A time resource allocation manner may be refined, so as to determine an interval at which the AP allocates a time resource to the STA once and a length of a time resource allocated each time.

According to a sixth aspect, the present disclosure provides an information indication method for a P2P link. The method includes: A second device receives and parses a QoS characteristics element. The QoS characteristics element includes a control information field, third indication information, and fourth indication information. The control information field includes a direction subfield. The direction subfield is set to 2 (that is, a first value is 2 in decimal system), to indicate that a data direction described by the QoS characteristics element is a P2P link. The third indication information indicates a mean service interval allocated to a first device for frame exchange on the P2P link. In other words, the third indication information indicates an interval at which a time resource is allocated to a first device once. The fourth indication information indicates medium time that is required by each mean service interval for transmission on the P2P link and that is requested by the first device. In other words, the fourth indication information indicates a size of a time resource allocated to the first device each time.

The P2P link is short for data transmission on the P2P link, that is, data (for example, an MSD or an aggregated MSDU) is sent from one non-access point station device to another non-access point station device. Herein, the non-access point station device may be a STA, or may be a non-AP MLD. In other words, the data direction is that the data is sent from one STA to another STA, or the data is sent from one non-AP MLD to another non-AP MLD.

The second device in the present disclosure is an AP (single-link) or an AP MLD.

With reference to the sixth aspect, in a possible implementation, the method further includes: The second device determines, based on indications of the third indication information and the fourth indication information, a time resource allocated to a service on the P2P link. Specifically, the second device may determine, based on the indication of the third indication information, the interval at which the time resource is allocated to the first device once, and the size of the time resource allocated each time may be determined based on the fourth indication information. In other words, the second device may allocate the time resource to the first device once at intervals of a time length indicated by the third indication information, and the size of the time resource allocated each time may be a time length indicated by the fourth indication information.

According to a seventh aspect, the present disclosure provides a communication apparatus. The communication apparatus may be a first device or a chip in the first device, for example, a Wi-Fi chip. The communication apparatus includes: a processing unit, configured to generate a QoS characteristics element, where the QoS characteristics element includes a control information field, third indication information, and fourth indication information, the control information field includes a direction subfield, the direction subfield is set to a first value, to indicate that a data direction described by the QoS characteristics element is a P2P link, the P2P link is that an MSDU or an aggregated MSDU is sent from one non-access point station device to another non-access point station device, the third indication information indicates a mean service interval allocated to the first device for frame exchange on the P2P link, and the fourth indication information indicates medium time that is required by each mean service interval for transmission on the P2P link and that is requested by the first device; and a transceiver unit, configured to send the QoS characteristics element.

According to an eighth aspect, the present disclosure provides a communication apparatus. The communication apparatus may be a second device or a chip in the second device, for example, a Wi-Fi chip. The communication apparatus includes: a transceiver unit, configured to receive a QoS characteristics element; and a parsing unit, configured to parse the QoS characteristics element, where the QoS characteristics element includes a control information field, third indication information, and fourth indication information, the control information field includes a direction subfield, the direction subfield is set to a first value, to indicate that a data direction described by the QoS characteristics element is a peer-to-peer (P2P) link, the P2P link is that a medium access control MAC service data unit MSDU or an aggregated MSDU is sent from one non-access point station device to another non-access point station device, the third indication information indicates a mean service interval allocated to a first device for frame exchange on the P2P link, and the fourth indication information indicates medium time that is required by each mean service interval for transmission on the P2P link and that is requested by the first device.

With reference to the eighth aspect, in a possible implementation, the communication apparatus further includes a determining unit, configured to determine, based on indications of the third indication information and the fourth indication information, a time resource allocated to a service on the P2P link.

The parsing unit and the determining unit may be integrated into one unit, for example, a processing unit.

In a possible implementation of any one of the fifth to eighth aspects, the QoS characteristics element may be carried in an SCS request frame.

In a possible implementation of any one of the fifth to eighth aspects, when the first device is the non-AP MLD, a P2P service may be transmitted on a multi-link (ML). Therefore, a length of medium time required by each mean service interval for transmission on each link needs to be indicated. Therefore, the QoS characteristics element further includes second indication information, and the second indication information indicates that at least one of multiple links is used as the P2P link described by the QoS characteristics element. In other words, the second indication information indicates at least one link to which the P2P link described by the QoS characteristics element in multiple links is mapped. If the second indication information indicates that n links in the multiple links are used as P2P links described by the QoS characteristics element, the QoS characteristics element includes n pieces of fourth indication information and n bandwidth fields. n is a positive integer. One piece of fourth indication information indicates a length of medium time that is required by each mean service interval for transmission on one of the n links and that is requested by the first device. One bandwidth field indicates a maximum bandwidth for transmission on one of the n links.

Optionally, the second indication information may be present in a form of a bitmap, and one bit of the second indication information corresponds to one link. When one bit of the second indication information is set to a second value (for example, 1), it indicates that a link corresponding to the bit is used as the P2P link described by the QoS characteristics element, or indicates that the P2P link described by the QoS characteristics element is mapped to a link corresponding to the bit.

In the solution, the P2P link is extended to MLDs, and a corresponding length indication manner for the medium time required by each mean service interval is designed, so that a time resource allocation manner can be refined, and an interval at which the AP MLD allocates a time resource to a link in the non-AP MLD once and a length of the time resource allocated each time are specified. In addition, advantages of the multi-link can be used, to improve transmission efficiency/a throughput of the P2P service and further reduce latency.

In a possible implementation of any one of the fifth to eighth aspects, the QoS characteristics element further includes fifth indication information, and the fifth indication information indicates a P2P link to which a traffic flow (or a P2P service) described by the QoS characteristics element is mapped.

In the solution, the fifth indication information is introduced into the QoS characteristics element, to indicate a P2P link that the traffic flow described by the QoS characteristics element is for, so that an AP side can distinguish between P2P services reported by a station side, thereby avoiding causing confusion to the AP side.

In a possible implementation of any one of the fifth to eighth aspects, the control information field further includes a TID subfield. A TID value indicated by the TID subfield is different from a TID value corresponding to any service on a P2P link set up between the first device and another device. In other words, when establishing a service, the first device allocates a unique TID to any service on a plurality of P2P links. Alternatively, a TID value indicated by the TID subfield is different from a TID value corresponding to a traffic flow on a P2P link that is historically reported by the first device based on the QoS characteristics element. In other words, the first device allocates a unique TID to a service that needs to be reported. A TID corresponding to a service that does not need to be reported may be reused on different P2P links.

In the solution, it is restricted that a P2P service has a unique TID, or that a P2P service that needs to be reported has a unique TID. In this way, the AP side does not receive a plurality of P2P services that have a same TID and that are reported by a same station. To be specific, when reporting P2P services, the station does not use a same TID for services on different P2P links, thereby avoiding causing confusion to the AP side.

According to a ninth aspect, the present disclosure provides an information indication method for a P2P link. The method includes: A first device generates and sends a QoS characteristics element. The QoS characteristics element includes a control information field and fifth indication information. The control information field includes a direction subfield. The direction subfield is set to 2 (that is, a first value is 2 in decimal system), to indicate that a data direction described by the QOS characteristics element is a P2P link. The fifth indication information indicates a P2P link to which a traffic flow (or a P2P service) described by the QoS characteristics element is mapped. The P2P link is that data (for example, an MSDU or an aggregated MSDU) is sent from one non-access point station device to another non-access point station device. Herein, the non-access point station device may be a STA, or may be a non-AP MLD. In other words, the data direction is that the data is sent from one STA to another STA, or the data is sent from one non-AP MLD to another non-AP MLD.

The first device in the present disclosure is a STA (single-link) or a non-AP MLD.

Because a station may set up P2P links/direct links with a plurality of other stations separately, when the station reports a characteristic of a P2P service to an AP associated with the station, the AP cannot learn of a P2P link that the reported service is for. Therefore, in the solution, the fifth indication information is introduced into the QoS characteristics element, to indicate a P2P link that the traffic flow described by the QoS characteristics element is for, so that an AP side can distinguish between P2P services reported by a station side, thereby avoiding causing confusion to the AP side.

According to a tenth aspect, the present disclosure provides an information indication method for a P2P link. The method includes: A second device receives and parses a QoS characteristics element. The QoS characteristics element includes a control information field and fifth indication information. The control information field includes a direction subfield. The direction subfield is set to 2 (that is, a first value is 2 in decimal system), to indicate that a data direction described by the QOS characteristics element is a P2P link. The fifth indication information indicates a P2P link to which a traffic flow (or a P2P service) described by the QoS characteristics element is mapped. The P2P link is that data (for example, an MSDU or an aggregated MSDU) is sent from one non-access point station device to another non-access point station device. Herein, the non-access point station device may be a STA, or may be a non-AP MLD. In other words, the data direction is that the data is sent from one STA to another STA, or the data is sent from one non-AP MLD to another non-AP MLD.

The second device in the present disclosure is an AP (single-link) or an AP MLD.

According to an eleventh aspect, the present disclosure provides a communication apparatus. The communication apparatus may be a first device or a chip in the first device, for example, a Wi-Fi chip. The communication apparatus includes: a processing unit, configured to generate a QoS characteristics element, where the QoS characteristics element includes a control information field and fifth indication information, the control information field includes a direction subfield, the direction subfield is set to a first value, to indicate that a data direction described by the QoS characteristics element is a P2P link, the P2P link is that an MSDU or an aggregated MSDU is sent from one non-access point station device to another non-access point station device, and the fifth indication information indicates a P2P link to which a traffic flow described by the QoS characteristics element is mapped; and a transceiver unit, configured to send the QoS characteristics element.

According to a twelfth aspect, the present disclosure provides a communication apparatus. The communication apparatus may be a second device or a chip in the second device, for example, a Wi-Fi chip. The communication apparatus includes: a transceiver unit, configured to receive a QoS characteristics element; and a parsing unit, configured to parse the QoS characteristics element, where the QoS characteristics element includes a control information field and fifth indication information, the control information field includes a direction subfield, the direction subfield is set to a first value, to indicate that a data direction described by the QoS characteristics element is a P2P link, the P2P link is that an MSDU or an aggregated MSDU is sent from one non-access point station device to another non-access point station device, and the fifth indication information indicates a P2P link to which a traffic flow described by the QoS characteristics element is mapped.

The parsing unit may also be referred to as a processing unit.

In a possible implementation of any one of the ninth to twelfth aspects, when the first device is the non-AP MLD, the QoS characteristics element further includes second indication information, and the second indication information indicates that at least one of multiple links is used as the P2P link described by the QoS characteristics element. In other words, the second indication information indicates at least one link to which the P2P link described by the QoS characteristics element in multiple links is mapped. If the second indication information indicates that n links in the multiple links are used as P2P links described by the QoS characteristics element, the QoS characteristics element includes n bandwidth fields. n is a positive integer. One bandwidth field indicates a maximum bandwidth for transmission on one of the n links. It should be understood that, when the first device is the non-AP MLD, although the P2P link is mapped to a multi-link (or the P2P service is transmitted on a multi-link), there is only one P2P link between one non-AP MLD and another non-AP MLD. Therefore, there is only one piece of fifth indication information in the QoS characteristics element.

Optionally, the second indication information may be present in a form of a bitmap, and one bit of the second indication information corresponds to one link. When one bit of the second indication information is set to a second value (for example, 1), it indicates that a link corresponding to the bit is used as the P2P link described by the QoS characteristics element, or indicates that the P2P link described by the QoS characteristics element is mapped to a link corresponding to the bit.

In the solution, the P2P link is extended to MLDs. In this way, the AP side can distinguish between P2P services reported by the station side, thereby avoiding causing confusion to the AP side. In addition, advantages of the multi-link can be used, to improve transmission efficiency/a throughput of the P2P service and further reduce latency.

According to a thirteenth aspect, the present disclosure provides an information indication method for a P2P link. The method includes: A first device generates and sends a QoS characteristics element. The QoS characteristics element includes a control information field, and the control information field includes a direction subfield and a TID subfield. The direction subfield is set to 2 (that is, a first value is 2 in decimal system), to indicate that a data direction described by the QoS characteristics element is a P2P link. A TID value indicated by the TID subfield is different from a TID value corresponding to any service on a P2P link set up between the first device and another device. In other words, when establishing a service, the first device allocates a unique TID to any service on a plurality of P2P links. Alternatively, a TID value indicated by the TID subfield is different from a TID value corresponding to a traffic flow on a P2P link that is historically reported by the first device based on the QoS characteristics element. In other words, the first device allocates a unique TID to a service that needs to be reported. A TID corresponding to a service that does not need to be reported may be reused on different P2P links.

The P2P link is that data (for example, an MSDU or an aggregated MSDU) is sent from one non-access point station device to another non-access point station device. Herein, the non-access point station device may be a STA, or may be a non-AP MLD. In other words, the data direction is that the data is sent from one STA to another STA, or the data is sent from one non-AP MLD to another non-AP MLD.

The first device in the present disclosure is a STA (single-link) or a non-AP MLD.

In the solution, it is restricted that a P2P service has a unique TID, or that a P2P service that needs to be reported has a unique TID. In this way, an AP side does not receive a plurality of P2P services that have a same TID and that are reported by a same station. To be specific, when reporting P2P services, the station does not use a same TID for services on different P2P links, thereby avoiding causing confusion to the AP side.

According to a fourteenth aspect, the present disclosure provides an information indication method for a P2P link. The method includes: A second device receives and parses a QoS characteristics element. The QoS characteristics element includes a control information field, and the control information field includes a direction subfield and a TID subfield. The direction subfield is set to 2 (that is, a first value is 2 in decimal system), to indicate that a data direction described by the QoS characteristics element is a P2P link. A TID value indicated by the TID subfield is different from a TID value corresponding to any service on a P2P link set up between a first device and another device. In other words, when establishing a service, the first device allocates a unique TID to any service on a plurality of P2P links. Alternatively, a TID value indicated by the TID subfield is different from a TID value corresponding to a traffic flow on a P2P link that is historically reported by a first device based on the QoS characteristics element. In other words, the first device allocates a unique TID to a service that needs to be reported. A TID corresponding to a service that does not need to be reported may be reused on different P2P links.

The P2P link is that data (for example, an MSDU or an aggregated MSDU) is sent from one non-access point station device to another non-access point station device. Herein, the non-access point station device may be a STA, or may be a non-AP MLD. In other words, the data direction is that the data is sent from one STA to another STA, or the data is sent from one non-AP MLD to another non-AP MLD.

The second device in the present disclosure is an AP (single-link) or an AP MLD.

According to a fifteenth aspect, the present disclosure provides a communication apparatus. The communication apparatus may be a first device or a chip in the first device, for example, a Wi-Fi chip. The communication apparatus includes: a processing unit, configured to generate a QoS characteristics element, where the QoS characteristics element includes a control information field, the control information field includes a direction subfield and a traffic identifier (TID) subfield, the direction subfield is set to a first value, to indicate that a data direction described by the QoS characteristics element is a peer-to-peer (P2P) link, the P2P link is that a medium access control (MAC) service data unit MSDU or an aggregated MSDU is sent from one non-access point station device to another non-access point station device, and a TID value indicated by the TID subfield is different from a TID value corresponding to any service on a P2P link set up between the first device and another device, or a TID value indicated by the TID subfield is different from a TID value corresponding to a traffic flow on a P2P link that is historically reported by the first device based on the QoS characteristics element; and a transceiver unit, configured to send the QoS characteristics element.

According to a sixteenth aspect, the present disclosure provides a communication apparatus. The communication apparatus may be a second device or a chip in the second device, for example, a Wi-Fi chip. The communication apparatus includes: a transceiver unit, configured to receive a QoS characteristics element; and a parsing unit, configured to parse the QoS characteristics element, where the QoS characteristics element includes a control information field, the control information field includes a direction subfield and a traffic identifier (TID) subfield, the direction subfield is set to a first value, to indicate that a data direction described by the QoS characteristics element is a peer-to-peer (P2P) link, the P2P link is that an MSDU or an aggregated MSDU is sent from one non-access point station device to another non-access point station device, and a TID value indicated by the TID subfield is different from a TID value corresponding to any service on a P2P link set up between a first device and another device, or a TID value indicated by the TID subfield is different from a TID value corresponding to a traffic flow on a P2P link that is historically reported by a first device based on the QoS characteristics element.

The parsing unit may also be referred to as a processing unit.

In a possible implementation of any one of the thirteenth to sixteenth aspects, when the first device is the non-AP MLD, the QoS characteristics element further includes second indication information, and the second indication information indicates that at least one of multiple links is used as the P2P link described by the QoS characteristics element. In other words, the second indication information indicates at least one link to which the P2P link described by the QoS characteristics element in multiple links is mapped. If the second indication information indicates that n links in the multiple links are used as P2P links described by the QoS characteristics element, the QoS characteristics element includes n bandwidth fields. n is a positive integer. One bandwidth field indicates a maximum bandwidth for transmission on one of the n links. It should be understood that, when the first device is the non-AP MLD, although the P2P link is mapped to a multi-link (or the P2P service is transmitted on a multi-link), there is only one P2P link between one non-AP MLD and another non-AP MLD. Therefore, there is only one piece of fifth indication information in the QoS characteristics element.

Optionally, the second indication information may be present in a form of a bitmap, and one bit of the second indication information corresponds to one link. When one bit of the second indication information is set to a second value (for example, 1), it indicates that a link corresponding to the bit is used as the P2P link described by the QoS characteristics element, or indicates that the P2P link described by the QoS characteristics element is mapped to a link corresponding to the bit.

In the solution, the P2P link is extended to MLDs. This does not cause confusion to the AP side. In addition, advantages of the multi-link can be used, to improve transmission efficiency/a throughput of the P2P service and further reduce latency.

According to a seventeenth aspect, the present disclosure provides a communication apparatus, specifically a first device, including a processor and a transceiver.

In an example embodiment, the processor is configured to generate a QoS characteristics element, where the QoS characteristics element includes a control information field and first indication information, the control information field includes a direction subfield, the direction subfield is set to a first value, to indicate that a data direction described by the QoS characteristics element is a P2P link, the P2P link is that an MSDU or an aggregated MSDU is sent from one non-access point station device to another non-access point station device, and the first indication information indicates a physical layer rate of the P2P link. The transceiver is configured to send the QoS characteristics element. Optionally, the first indication information includes one or more of the following: a physical layer rate, a modulation and coding scheme, and a number of spatial streams.

In an example embodiment, the processor is configured to generate a QoS characteristics element, where the QoS characteristics element includes a control information field, third indication information, and fourth indication information, the control information field includes a direction subfield, the direction subfield is set to a first value, to indicate that a data direction described by the QoS characteristics element is a P2P link, the P2P link is that an MSDU or an aggregated MSDU is sent from one non-access point station device to another non-access point station device, the third indication information indicates a mean service interval allocated to the first device for frame exchange on the P2P link, and the fourth indication information indicates medium time that is required by each mean service interval for transmission on the P2P link and that is requested by the first device. The transceiver is configured to send the QoS characteristics element.

In an example embodiment, the processor is configured to generate a QoS characteristics element, where the QoS characteristics element includes a control information field and fifth indication information, the control information field includes a direction subfield, the direction subfield is set to a first value, to indicate that a data direction described by the QoS characteristics element is a P2P link, the P2P link is that an MSDU or an aggregated MSDU is sent from one non-access point station device to another non-access point station device, and the fifth indication information indicates a P2P link to which a traffic flow described by the QoS characteristics element is mapped. The transceiver is configured to send the QoS characteristics element.

In an example embodiment, the processor is configured to generate a QoS characteristics element, where the QoS characteristics element includes a control information field, the control information field includes a direction subfield and a traffic identifier (TID) subfield, the direction subfield is set to a first value, to indicate that a data direction described by the QoS characteristics element is a P2P link, the P2P link is that an MSDU or an aggregated MSDU is sent from one non-access point station device to another non-access point station device, and a TID value indicated by the TID subfield is different from a TID value corresponding to any service on a P2P link set up between the first device and another device, or a TID value indicated by the TID subfield is different from a TID value corresponding to a traffic flow on a P2P link that is historically reported by the first device based on the QoS characteristics element. The transceiver is configured to send the QoS characteristics element.

According to an eighteenth aspect, the present disclosure provides a communication apparatus, specifically a second device, including a processor and a transceiver.

In an example embodiment, the transceiver is configured to receive a QoS characteristics element. The processor is configured to parse the QoS characteristics element, where the QoS characteristics element includes a control information field and first indication information, the control information field includes a direction subfield, the direction subfield is set to a first value, to indicate that a data direction described by the QoS characteristics element is a P2P link, the P2P link is that an MSDU or an aggregated MSDU is sent from one non-access point station device to another non-access point station device, and the first indication information indicates a physical layer rate of the P2P link. Optionally, the first indication information includes one or more of the following: a physical layer rate, a modulation and coding scheme, and a number of spatial streams.

Optionally, the processor is further configured to determine, based on an indication of the first indication information, a time resource allocated to a service on the P2P link.

In an example embodiment, the transceiver is configured to receive a QoS characteristics element. The processor is configured to parse the QoS characteristics element, where the QOS characteristics element includes a control information field, third indication information, and fourth indication information, the control information field includes a direction subfield, the direction subfield is set to a first value, to indicate that a data direction described by the QoS characteristics element is a P2P link, the P2P link is that an MSDU or an aggregated MSDU sent from one non-access point station device to another non-access point station device, the third indication information indicates a mean service interval allocated to a first device for frame exchange on the P2P link, and the fourth indication information indicates medium time that is required by each mean service interval for transmission on the P2P link and that is requested by the first device.

Optionally, the processor is further configured to determine, based on indications of the third indication information and the fourth indication information, a time resource allocated to a service on the P2P link.

In an example embodiment, the transceiver receives a QoS characteristics element. The processor is configured to parse the QOS characteristics element, where the QoS characteristics element includes a control information field and fifth indication information, the control information field includes a direction subfield, the direction subfield is set to a first value, to indicate that a data direction described by the QoS characteristics element is a P2P link, the P2P link is that an MSDU or an aggregated MSDU is sent from one non-access point station device to another non-access point station device, and the fifth indication information indicates a P2P link to which a traffic flow described by the QoS characteristics element is mapped.

In an example embodiment, the transceiver is configured to receive a QoS characteristics element. The processor is configured to parse the QoS characteristics element, where the QoS characteristics element includes a control information field, the control information field includes a direction subfield and a traffic identifier (TID) subfield, the direction subfield is set to a first value, to indicate that a data direction described by the QoS characteristics element is a P2P link, the P2P link is that an MSDU or an aggregated MSDU is sent from one non-access point station device to another non-access point station device, and a TID value indicated by the TID subfield is different from a TID value corresponding to any service on a P2P link set up between a first device and another device, or a TID value indicated by the TID subfield is different from a TID value corresponding to a traffic flow on a P2P link that is historically reported by a first device based on the QoS characteristics element.

According to a nineteenth aspect, the present disclosure provides an apparatus. The apparatus is implemented in a product form of a chip, and includes an input/output interface and a processing circuit. The apparatus is a chip in a first device.

In an example embodiment, the processing circuit is configured to generate a QoS characteristics element, where the QoS characteristics element includes a control information field and first indication information, the control information field includes a direction subfield, the direction subfield is set to a first value, to indicate that a data direction described by the QoS characteristics element is a P2P link, the P2P link is that an MSDU or an aggregated MSDU is sent from one non-access point station device to another non-access point station device, and the first indication information indicates a physical layer rate of the P2P link. The input/output interface is configured to: output the QoS characteristics element, and send the QoS characteristics element through an antenna after the QoS characteristics element is processed through a radio frequency circuit. Optionally, the first indication information includes one or more of the following: a physical layer rate, a modulation and coding scheme, and a number of spatial streams.

In an example embodiment, the processing circuit is configured to generate a QoS characteristics element, where the QoS characteristics element includes a control information field, third indication information, and fourth indication information, the control information field includes a direction subfield, the direction subfield is set to a first value, to indicate that a data direction described by the QoS characteristics element is a P2P link, the P2P link is that an MSDU or an aggregated MSDU is sent from one non-access point station device to another non-access point station device, the third indication information indicates a mean service interval allocated to the first device for frame exchange on the P2P link, and the fourth indication information indicates medium time that is required by each mean service interval for transmission on the P2P link and that is requested by the first device. The input/output interface is configured to: output the QoS characteristics element, and send the QoS characteristics element through an antenna after the QoS characteristics element is processed through a radio frequency circuit.

In an example embodiment, the processing circuit is configured to generate a QoS characteristics element, where the QoS characteristics element includes a control information field and fifth indication information, the control information field includes a direction subfield, the direction subfield is set to a first value, to indicate that a data direction described by the QoS characteristics element is a P2P link, the P2P link is that an MSDU or an aggregated MSDU is sent from one non-access point station device to another non-access point station device, and the fifth indication information indicates a P2P link to which a traffic flow described by the QoS characteristics element is mapped. The input/output interface is configured to: output the QoS characteristics element, and send the QoS characteristics element through an antenna after the QoS characteristics element is processed through a radio frequency circuit.

In an example embodiment, the processing circuit is configured to generate a QoS characteristics element, where the QoS characteristics element includes a control information field, the control information field includes a direction subfield and a traffic identifier (TID) subfield, the direction subfield is set to a first value, to indicate that a data direction described by the QoS characteristics element is a P2P link, the P2P link is that an MSDU or an aggregated MSDU is sent from one non-access point station device to another non-access point station device, and a TID value indicated by the TID subfield is different from a TID value corresponding to any service on a P2P link set up between the first device and another device, or a TID value indicated by the TID subfield is different from a TID value corresponding to a traffic flow on a P2P link that is historically reported by the first device based on the QoS characteristics element. The input/output interface is configured to: output the QoS characteristics element, and send the QoS characteristics element through an antenna after the QoS characteristics element is processed through a radio frequency circuit.

According to a twentieth aspect, the present disclosure provides an apparatus. The apparatus is implemented in a product form of a chip, and includes an input/output interface and a processing circuit. The apparatus is a chip in a second device.

In an example embodiment, the input/output interface is configured to input a QoS characteristics element received through an antenna and a radio frequency circuit. The processing circuit is configured to parse the QoS characteristics element, where the QoS characteristics element includes a control information field and first indication information, the control information field includes a direction subfield, the direction subfield is set to a first value, to indicate that a data direction described by the QoS characteristics element is a P2P link, the P2P link is that an MSDU or an aggregated MSDU is sent from one non-access point station device to another non-access point station device, and the first indication information indicates a physical layer parameter of the P2P link. Optionally, the first indication information includes one or more of the following: a physical layer rate, a modulation and coding scheme, and a number of spatial streams.

Optionally, the processing circuit is further configured to determine, based on an indication of the first indication information, a time resource allocated to a service on the P2P link.

In an example embodiment, the input/output interface is configured to input a QoS characteristics element received through an antenna and a radio frequency circuit. The processing circuit is configured to parse the QoS characteristics element, where the QOS characteristics element includes a control information field, third indication information, and fourth indication information, the control information field includes a direction subfield, the direction subfield is set to a first value, to indicate that a data direction described by the QoS characteristics element is a P2P link, the P2P link is that an MSDU or an aggregated MSDU sent from one non-access point station device to another non-access point station device, the third indication information indicates a mean service interval allocated to a first device for frame exchange on the P2P link, and the fourth indication information indicates medium time that is required by each mean service interval for transmission on the P2P link and that is requested by the first device.

Optionally, the processing circuit is further configured to determine, based on indications of the third indication information and the fourth indication information, a time resource allocated to a service on the P2P link.

In an example embodiment, the input/output interface is configured to input a QoS characteristics element received through an antenna and a radio frequency circuit. The processing circuit is configured to parse the QOS characteristics element, where the QoS characteristics element includes a control information field and fifth indication information, the control information field includes a direction subfield, the direction subfield is set to a first value, to indicate that a data direction described by the QoS characteristics element is a P2P link, the P2P link is that an MSDU or an aggregated MSDU is sent from one non-access point station device to another non-access point station device, and the fifth indication information indicates a P2P link to which a traffic flow described by the QoS characteristics element is mapped.

In an example embodiment, the input/output interface is configured to input a QoS characteristics element received through an antenna and a radio frequency circuit. The processing circuit is configured to parse the QOS characteristics element, where the QoS characteristics element includes a control information field, the control information field includes a direction subfield and a traffic identifier (TID) subfield, the direction subfield is set to a first value, to indicate that a data direction described by the QoS characteristics element is a P2P link, the P2P link is that an MSDU or an aggregated MSDU is sent from one non-access point station device to another non-access point station device, and a TID value indicated by the TID subfield is different from a TID value corresponding to any service on a P2P link set up between a first device and another device, or a TID value indicated by the TID subfield is different from a TID value corresponding to a traffic flow on a P2P link that is historically reported by a first device based on the QoS characteristics element.

According to a twenty-first aspect, the present disclosure provides a computer-readable storage medium. The computer-readable storage medium stores program instructions, and when the program instructions are run on a computer, the computer is enabled to perform the information indication method for a P2P link according to the first aspect, the second aspect, the fifth aspect, the sixth aspect, the ninth aspect, the tenth aspect, the thirteenth aspect, or the fourteenth aspect.

According to a twenty-second aspect, the present disclosure provides a computer program product including program instructions. When the computer program product runs on a computer, the computer is enabled to perform the information indication method for a P2P link according to the first aspect, the second aspect, the fifth aspect, the sixth aspect, the ninth aspect, the tenth aspect, the thirteenth aspect, or the fourteenth aspect.

In embodiments of the present disclosure, the physical layer parameter (for example, the physical layer rate, the modulation and coding scheme, or the number of spatial streams) of the P2P link may be reported based on the QoS characteristics element. Therefore, when receiving the characteristic of the service on the P2P link, the AP side may reuse the uplink and downlink time allocation algorithms. In addition, the P2P link may be extended to the multi-link, to improve the transmission efficiency/throughput.

### BRIEF DESCRIPTION OF DRAWINGS

To describe technical solutions in embodiments of the present disclosure more clearly, the following briefly describes accompanying drawings used for describing embodiments.

FIG. 1 is an example schematic diagram of an architecture of a wireless communication system according to an embodiment of the present disclosure;

FIG. 2a is an example schematic diagram of a structure of an access point according to an embodiment of the present disclosure;

FIG. 2b is an example schematic diagram of a structure of a station according to an embodiment of the present disclosure;

FIG. 3a is an example schematic diagram of a structure of a multi-link device according to an embodiment of the present disclosure;

FIG. 3b is an example schematic diagram of a structure of a multi-link device according to an embodiment of the present disclosure;

FIG. 4 is an example schematic diagram of multi-link communication according to an embodiment of the present disclosure;

FIG. 5a is an example schematic diagram of a P2P link set up between STAs according to an embodiment of the present disclosure;

FIG. 5b is an example schematic diagram of a P2P link set up between non-AP MLDs according to an embodiment of the present disclosure;

FIG. 6 is an example schematic diagram of a frame format of a QoS characteristics element according to an embodiment of the present disclosure;

FIG. 7 is an example schematic diagram of a frame format of a control information field according to an embodiment of the present disclosure;

FIG. 8 is an example first schematic flowchart of an information indication method for a P2P link according to an embodiment of the present disclosure;

FIG. 9a is an example schematic diagram of a frame format of first indication information in a QoS characteristics element according to an embodiment of the present disclosure;

FIG. 9b is an example schematic diagram of another frame format of first indication information in a QoS characteristics element according to an embodiment of the present disclosure;

FIG. 10a is an example schematic diagram of a frame format of first indication information and a frame format of second indication information in a QoS characteristics element according to an embodiment of the present disclosure;

FIG. 10b is an example schematic diagram of another frame format of first indication information and another frame format of second indication information in a QoS characteristics element according to an embodiment of the present disclosure;

FIG. 11 is an example schematic diagram of a frame format of third indication information in a QoS characteristics element according to an embodiment of the present disclosure;

FIG. 12 is an example schematic diagram of a frame format of fifth indication information in a QoS characteristics element according to an embodiment of the present disclosure;

FIG. 13 is an example second schematic flowchart of an information indication method for a P2P link according to an embodiment of the present disclosure;

FIG. 14a is an example schematic diagram of a frame format of third indication information and a frame format of fourth indication information according to an embodiment of the present disclosure;

FIG. 14b is an example schematic diagram of another frame format of third indication information and another frame format of fourth indication information according to an embodiment of the present disclosure;

FIG. 15 is an example third schematic flowchart of an information indication method for a P2P link according to an embodiment of the present disclosure;

FIG. 16 is an example schematic diagram of a frame format of fifth indication information according to an embodiment of the present disclosure;

FIG. 17 is an example fourth schematic flowchart of an information indication method for a P2P link according to an embodiment of the present disclosure;

FIG. 18 is an example schematic diagram of a structure of a communication apparatus 1 according to an embodiment of the present disclosure;

FIG. 19 is an example schematic diagram of a structure of a communication apparatus 2 according to an embodiment of the present disclosure; and

FIG. 20 is an example schematic diagram of a structure of a communication apparatus 1000 according to an embodiment of the present disclosure.

### DESCRIPTION OF EMBODIMENTS

The following clearly and completely describes the technical solutions in embodiments of the present disclosure with reference to the accompanying drawings in embodiments of the present disclosure.

In the present disclosure, unless otherwise specified, “/” means “or”. For example, A/B may indicate A or B. A term “and/or” in this specification describes only an association relationship between associated objects and indicates that there may be three relationships. For example, A and/or B may indicate one of the three cases: Only A exists, both A and B exist, or only B exists. In addition, “at least one” means one or more, and “a plurality of” means two or more. “At least one of the following items (pieces)” or a similar expression thereof means any combination of these items, including any combination of singular items (pieces) or plural items (pieces). For example, at least one of a, b, or c may indicate a, b, c, a and b, a and c, b and c, or a, b, and c. Herein, a, b, and c may be singular or plural.

In the present disclosure, terms such as “first” and “second” do not limit a quantity and an execution sequence, and the terms such as “first” and “second” do not indicate a definite difference.

In the present disclosure, the term “example” or “for example” is used to represent giving an example, an illustration, or a description. Any embodiment or design scheme described as “example”, “such as” or “for example” in the present disclosure should not be explained as being more preferred or having more advantages than another embodiment or design scheme. Exactly, use of the term “example”, “such as”, “for example”, or the like is intended to present a concept in a specific manner.

In the present disclosure, an element represented in a singular form is intended to represent “one or more”, but does not represent “one and only one”, unless otherwise specified.

It should be understood that, in embodiments of the present disclosure, “B corresponding to A” and “B to which A is mapped” indicate that B is associated with A, and B may be determined based on A. However, it should be further understood that determining B based on A does not mean that B is determined based only on A. B may alternatively be determined based on A and/or other information.

The technical solutions provided in the present disclosure are applicable to various communication systems, for example, a system using an 802.11 standard. For example, the 802.11 standard includes but is not limited to the 802.11be standard or a next-generation 802.11 standard. A scenario to which the technical solutions of the present disclosure are applicable includes communication between an AP and one or more STAs, communication between an access point multi-link device (AP multi-link device, AP MLD) and one or more non-access point multi-link devices (non-AP multi-link devices, non-AP MLDs), communication between STAs, or communication between non-AP MLDs. In embodiments of the present disclosure, the term “communication” may also be described as “data transmission”, “information transmission”, or “transmission”. The term “transmission” may generally refer to sending and receiving.

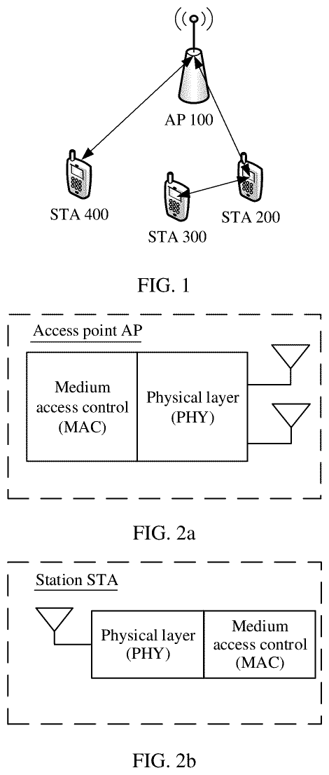

FIG. 1 is a schematic diagram of an architecture of a wireless communication system according to an embodiment of the present disclosure. As shown in FIG. 1, the wireless communication system may include one or more APs (for example, an AP 100 in FIG. 1) and one or more STAs (for example, a STA 200, a STA 300, and a STA 400 in FIG. 1). Both the AP and the STA support a WLAN communication protocol. The communication protocol may include the 802.11be (or referred to as Wi-Fi 7, or an EHT protocol), and may further include protocols such as the 802.11ax and the 802.11ac. Certainly, with continuous evolution and development of communication technologies, the communication protocol may further include a next generation protocol of the 802.11be, and the like. A WLAN is used as an example, an apparatus for implementing a method in the present disclosure may be an AP or a STA in the WLAN, or a chip or a processing system installed in the AP or the STA.

Optionally, an access point (for example, the AP 100 in FIG. 1) in the present disclosure is an apparatus having a wireless communication function, supports communication using a WLAN protocol, and has a function of communicating with another device (for example, a station or another access point) in a WLAN network. Certainly, the access point may further have a function of communicating with another device. In a WLAN system, an access point may be referred to as an access point station (AP STA). The apparatus having the wireless communication function may be an entire device, or may be a chip, a processing system, or the like installed in the entire device. A device on which the chip or the processing system is installed may implement, under control of the chip or the processing system, the methods and the functions in embodiments of the present disclosure. An AP in embodiments of the present disclosure is an apparatus that provides a service for a STA, and may support the 802.11 series protocols. For example, the AP may be a communication entity such as a communication server, a router, a switch, or a bridge. The AP may include a macro base station, a micro base station, a relay station, and the like in various forms. Certainly, the AP may alternatively be a chip and a processing system in each of these devices in various forms, to implement the methods and the functions in embodiments of the present disclosure.

Optionally, a station in the present disclosure (for example, the STA 200, the STA 300, or the STA 400 in FIG. 1) is an apparatus having a wireless communication function, supports communication using a WLAN protocol, and has a capability of communicating with another station or access point in a WLAN network. In a WLAN system, the station may be referred to as a non-access point station (non-AP STA). For example, the STA is any user communication device that allows a user to communicate with the AP and then communicate with the WLAN. The apparatus having the wireless communication function may be an entire device, or may be a chip, a processing system, or the like installed in the entire device. A device on which the chip or the processing system is installed may implement, under control of the chip or the processing system, the methods and the functions in embodiments of the present disclosure. For example, the STA may be user equipment that can be connected to an internet, for example, a tablet computer, a desktop computer, a laptop computer, a notebook computer, an ultra-mobile personal computer (UMPC), a handheld computer, a netbook, a personal digital assistant (PDA), or a mobile phone, an internet of things node in an internet of things, an in-vehicle communication apparatus in an internet of vehicles, an entertainment device, a game device or system, a global positioning system device, or the like. Alternatively, the STA may be a chip and a processing system in each of the foregoing terminals.

In some embodiments, in the wireless communication system shown in FIG. 1, the AP may be replaced with an AP MLD, and the STA may be replaced with a non-AP MLD. In other words, the technical solutions provided in the present disclosure may also be applied to a scenario of communication between multi-link devices (MLDs). The multi-link device is a wireless communication device that supports concurrent transmission on multiple links. Compared with a device that supports transmission on only a single link, the multi-link device has higher transmission efficiency and a higher throughput. The multi-link device includes one or more affiliated stations (affiliated STAs). The affiliated station is a logical station and may operate on a link, a frequency band, or a channel. The affiliated station may be an access point or a non-access point station (non-AP STA). In the 802.11be, a multi-link device whose affiliated station is an AP is referred to as an AP multi-link device (AP MLD), and a multi-link device whose affiliated station is a non-AP STA is referred to as a non-AP multi-link device (non-AP MLD).

Optionally, a multi-link device in the present disclosure (which may be a non-AP MLD or an AP MLD) is an apparatus having a wireless communication function. The apparatus may be an entire device, or may be a chip, a processing system, or the like installed in the entire device. A device on which the chip or the processing system is installed may implement, under control of the chip or the processing system, the methods and functions in embodiments of the present disclosure. For example, a non-AP MLD in embodiments of the present disclosure has a wireless transceiver function, may support the 802.11 series protocols, and may communicate with an AP MLD, a single-link device, or another non-AP MLD. For example, the non-AP MLD is any user communication device that allows a user to communicate with an AP and then communicate with a WLAN. For example, the non-AP MLD may be user equipment that can be connected to a network, for example, a tablet computer, a desktop computer, a laptop computer, a notebook computer, an ultra-mobile personal computer (UMPC), a handheld computer, a netbook, a personal digital assistant (PDA), or a mobile phone, an internet of things node in an internet of things, an in-vehicle communication apparatus in an internet of vehicles, or the like. Alternatively, the non-AP MLD may be a chip and a processing system in each of the foregoing terminals. The AP MLD may be an apparatus that provides a service for the non-AP MLD, and may support the 802.11 series protocols. For example, the AP MLD may be a communication entity such as a communication server, a router, a switch, or a bridge, or the AP MLD may include a macro base station, a micro base station, a relay station, and the like in various forms. Certainly, the AP MLD may alternatively be a chip and a processing system in each of these devices in various forms, to implement the methods and the functions in embodiments of the present disclosure. An 802.11 protocol may be a protocol that supports the 802.11be or is compatible with the 802.11be.

A WLAN system can provide high-speed and low-latency transmission. With continuous evolution of WLAN application scenarios, the WLAN system is applied to more scenarios or industries, for example, the internet of things industry, the internet of vehicles industry, the banking industry, enterprise offices, exhibition halls of stadiums, concert halls, hotel rooms, dormitories, wards, classrooms, supermarkets, squares, streets, production workshops and warehousing. Certainly, a device (for example, an access point or a station) that supports WLAN communication may be a sensor node (for example, a smart water meter, a smart electricity meter, or a smart air detection node) in a smart city, a smart device (for example, a smart camera, a projector, a display screen, a television, a stereo, a refrigerator, or a washing machine) in a smart home, a node in an internet of things, an entertainment terminal (for example, a wearable device such as augmented reality (AR) or virtual reality (VR)), a smart device (for example, a printer, a projector, a speaker, or a stereo) in smart office, an internet of vehicles device in an internet of vehicles, an infrastructure (for example, a vending machine, a self-service navigation console of a supermarket, a self-service cashier, or a self-service ordering machine) in a daily life scenario, a device in a large sports and music venue, and the like. Specific forms of the STA, the AP, and the MLD are not limited in embodiments of the present disclosure. This is merely an example for description herein.

It should be understood that an 802.11 standard focuses on a physical layer (PHY) and a medium access control (MAC) layer. For example, FIG. 2a is a schematic diagram of a structure of an access point according to an embodiment of the present disclosure. The AP may be of a multi-antenna/multi-radio-frequency, or may be of a single-antenna/single-radio-frequency. The antenna/radio frequency is used to send/receive a data packet (the data packet in this specification may also be referred to as a physical layer protocol data unit (PHY protocol data unit, PPDU)). In an implementation, an antenna part or a radio frequency part of the AP may be separated from a main body of the AP, that is, the AP is in a structure of a remote layout. In FIG. 2a, the AP may include a physical layer processing circuit and a medium access control processing circuit. The physical layer processing circuit may be configured to process a physical layer signal, and the MAC layer processing circuit may be configured to process a MAC layer signal. For another example, FIG. 2b is a schematic diagram of a structure of a station according to an embodiment of the present disclosure. FIG. 2b is a schematic diagram of a structure of a single-antenna/single-radio-frequency STA. In an actual scenario, the STA may alternatively be of a multi-antenna/multi-radio frequency, and may be a device with more than two antennas. The antenna/radio frequency is configured to send/receive a data packet. In an implementation, an antenna part or a radio frequency part of the STA may be separated from a main body of the STA, that is, the STA is in a structure of a remote layout. In FIG. 2b, the STA may include a PHY processing circuit and a MAC processing circuit. The physical layer processing circuit may be configured to process a physical layer signal, and the MAC layer processing circuit may be configured to process a MAC layer signal.

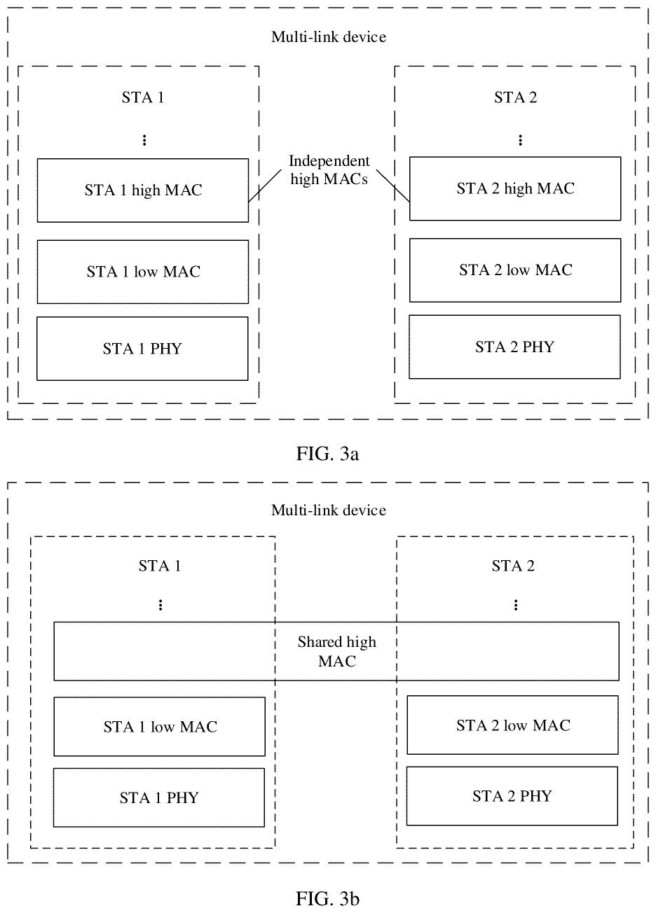

Optionally, FIG. 3a is a schematic diagram of a structure of a multi-link device according to an embodiment of the present disclosure. As shown in FIG. 3a, a plurality of STAs included in the multi-link device are independent of each other at a low MAC layer and a PHY layer, and are also independent of each other at a high MAC layer. FIG. 3b is a schematic diagram of another structure of a multi-link device according to an embodiment of the present disclosure. As shown in FIG. 3b, a plurality of STAs included in the multi-link device are independent of each other at a low MAC layer and a PHY layer, and share a high MAC layer. Certainly, in a multi-link communication process, a non-AP MLD may use a structure with independent high MAC layers, and an AP MLD uses a structure with a shared high MAC layer; or a non-AP MLD may use a structure with a shared high MAC layer, and an AP MLD uses a structure with independent high MAC layers; or each of a non-AP MLD and an AP MLD may use a structure with a shared high MAC layer; or each of a non-AP MLD and an AP MLD may use a structure with independent high MAC layers. A schematic diagram of an internal structure of the multi-link device is not limited in embodiments of the present disclosure. FIG. 3a and FIG. 3b are merely examples for description. For example, the high MAC layer or the low MAC layer may be implemented by one processor in a chip system of the multi-link device, or may be implemented by different processing modules in a chip system.

For example, the multi-link device in embodiments of the present disclosure may be a single-antenna device, or may be a multi-antenna device. For example, the multi-link device may be a device with more than two antennas. A quantity of antennas included in the multi-link device is not limited in embodiments of the present disclosure.

The foregoing content briefly describes a system architecture in embodiments of the present disclosure, and the following briefly describes some terms or nouns in the present disclosure.

### 1. Multi-Link (ML)

In order to achieve a technical goal of extremely high throughput, the next-generation standard 802.11be uses the multi-link (ML) as one of key technologies. A core idea of the multi-link is that a WLAN device that supports a next-generation 802.11 standard has a capability of sending and receiving on a multi-band, so that a larger bandwidth can be used for data transmission, thereby significantly improving a throughput. Multiple bands include but are not limited to a 2.4 GHz Wi-Fi frequency band, a 5 GHz Wi-Fi frequency band, and a 6 GHz Wi-Fi frequency band. In addition, the 802.11be can reduce latency and improve robustness through the multi-link (ML).

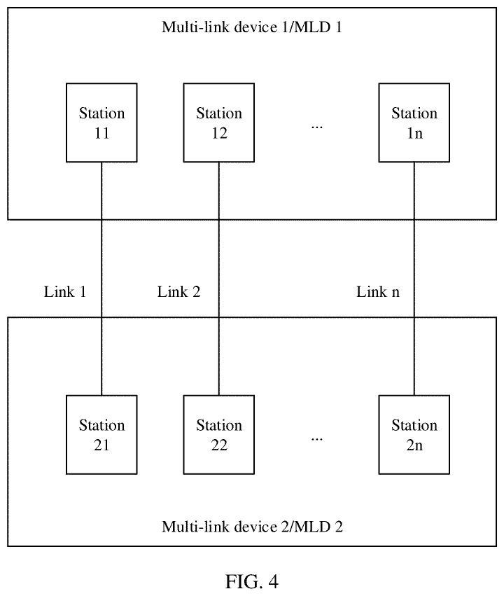

FIG. 4 is a schematic diagram of multi-link communication according to an embodiment of the present disclosure. As shown in FIG. 4, a multi-link device 1 (MLD 1) includes n stations: a station 11, a station 12, . . . , and a station 1n. A multi-link device 2 (MLD 2) also includes n stations: a station 21, a station 22, . . . , and a station 2n. A station in one MLD may set up a link (or a channel, or a frequency band) with a station in another MLD for communication. The communication between the MLDs is multi-link communication. A link 1 to a link n in FIG. 4 form a multi-link. In other words, the MLD 1 and the MLD 2 may perform concurrent communication on the link 1, the link 2, . . . , and the link n.

It should be understood that one link in multiple links may be understood as one frequency band or one channel.

### 2. Peer-to-Peer (P2P) Link

The P2P link is set up by two non-AP STAs through tunneled direct link setup (TDLS) or another P2P protocol. In some scenarios, the P2P link is also referred to as a direct link: data (for example, a MAC service data unit (MSDU) or an aggregated MSDU (A-MSDU)) is sent from one non-AP STA to another non-AP STA (Direct link: MSDUs or A-MSDUs are sent from the non-AP STA to another non-AP STA). The P2P link may also be understood as a direct link within a quality of service (QOS) basic service set (basic service set, BSS), a tunneled direct link setup (TDLS) link, or station-to-station (STA-to-STA) communication in an independent basic service set (IBS). (peer-to-peer link: A direct link within a quality of service (QOS) basic service set (BSS), a tunneled direct link setup (TDLS) link, or a station-to-station (STA-to-STA) communication in an independent basic service set (IBSS).)

After a concept of a multi-link (ML) is introduced in the 802.11be standard, because one service may be mapped to multiple links, correspondingly, P2P data transmission may also be performed between non-AP MLD devices. In other words, the P2P link may also be that the data (for example, the MSDU or the A-MSDU) is sent from the non-AP MLD to the another non-AP MLD.

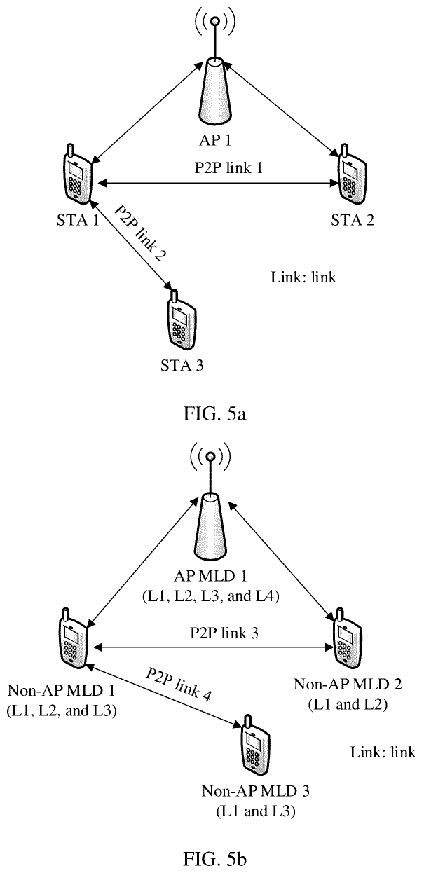

For example, FIG. 5a is a schematic diagram of a P2P link set up between STAs according to an embodiment of the present disclosure. As shown in FIG. 5a, both a STA 1 and a STA 2 are associated with an AP 1, and a STA 3 is not associated with the AP 1. The STA 1 may set up one (or one piece of) P2P link that is referred to as a P2P link 1 herein with the STA 2. The STA 1 may further set up another (or another piece of) P2P link that is referred to as a P2P link 2 herein with the STA 3. Herein, the P2P link 1 and the P2P link 2 share one physical channel or one frequency band of the STA 1.

For another example, FIG. 5b is a schematic diagram of a P2P link set up between non-AP MLDs according to an embodiment of the present disclosure. As shown in FIG. 5b, both a non-AP MLD 1 and a non-AP MLD 2 are associated with an AP MLD 1, and a non-AP MLD 3 is not associated with the AP MLD 1. The AP MLD 1 includes four APs: an AP 1, an AP 2, an AP 3, and an AP 4 that correspond to four links: L1, L2, L3, and L4 respectively (L1, L2, L3, and L4 indicate a link 1, a link 2, a link 3, and a link 4 respectively. The same is true in the following). These four links form a multi-link (ML). The non-AP MLD 1 includes three non-AP STAs that correspond to three links between the non-AP STAs and the AP MLD 1: L1, L2, and L3 respectively. In other words, the non-AP MLD 1 operates on L1, L2, and L3. The non-AP MLD 2 includes two non-AP STAs that correspond to two links between the non-AP STAs and the AP MLD 1: L1 and L2 respectively. In other words, the non-AP MLD 2 operates on L1 and L2. No link is set up between the non-AP MLD 3 and the AP MLD 1, but there are two links between the non-AP MLD 3 and the non-AP MLD 1: L1 and L3. In other words, the non-AP MLD 3 operates on L1 and L3. The non-AP MLD 1 may set up one (or one piece of) P2P link that is referred to as a P2P link 3 herein with the non-AP MLD 2. The P2P link 3 is mapped to L1 and L2. In other words, L1 and L2 are used as P2P links. The non-AP MLD 1 may also set up another (or another piece of) P2P link that is referred to as a P2P link 4 herein with the non-AP MLD 3. The P2P link 4 is mapped to L1 and L3. In other words, L1 and L3 are used as P2P links. Because one link in multiple links may be understood as one frequency band or one channel, mapping of the P2P link to the multi-link may be understood as mapping of the P2P link to a plurality of channels or a plurality of frequency bands, or may be understood as that a service on the P2P link is transmitted through a plurality of channels or a plurality of frequency bands, or a plurality of channels or a plurality of frequency bands may be used as P2P links.

When a station supports a service with a delay-sensitive characteristic, the characteristic of the service may be reported to an AP associated with the station, to request the AP to allocate a time resource to meet a transmission requirement of the service. In an implementation, a station in embodiments of the present disclosure may report a characteristic parameter of a latency-sensitive service/low-latency service through a quality of service (QOS) characteristics element. The QoS characteristics element contains a set of parameters that define a characteristic and a QoS expectation of a traffic flow (The QoS characteristics element contains a set of parameters that define the characteristics and QoS expectations of a traffic flow). In other words, the QoS characteristics element indicates/describes information such as a traffic identifier (TID) to which a traffic flow is mapped and a corresponding QoS parameter.

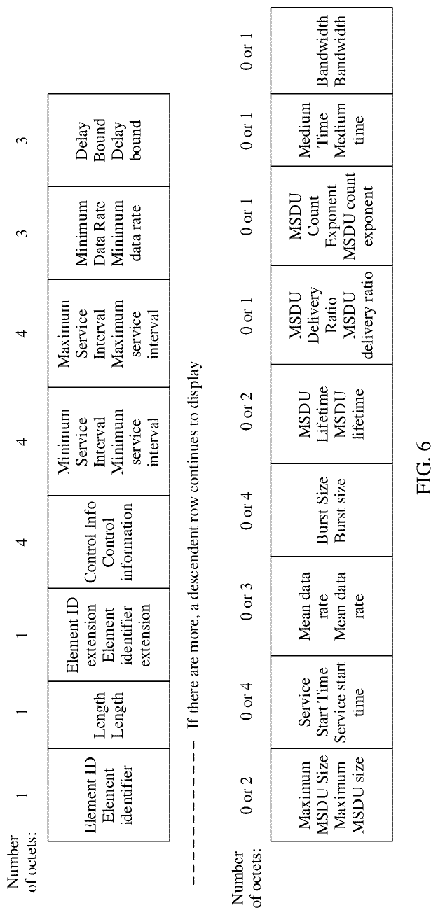

FIG. 6 is a schematic diagram of a frame format of a QoS characteristics element according to an embodiment of the present disclosure. As shown in FIG. 6, the QoS characteristics element includes one or more of the following fields: an element identifier (element ID) field, a length field, an element identifier extension (element ID extension) field, a control information (control info) field, a minimum service interval field, a maximum service interval field, a minimum data rate field, a delay bound field, a maximum MSDU size field, a service start time field, a mean data rate field, a burst size field, an MSDU lifetime field, an MSDU delivery ratio field, an MSDU count exponent field, a medium time field, and a bandwidth field. For definitions of the element identifier field, the length field, and the element identifier extension field, refer to the descriptions in the existing standard.

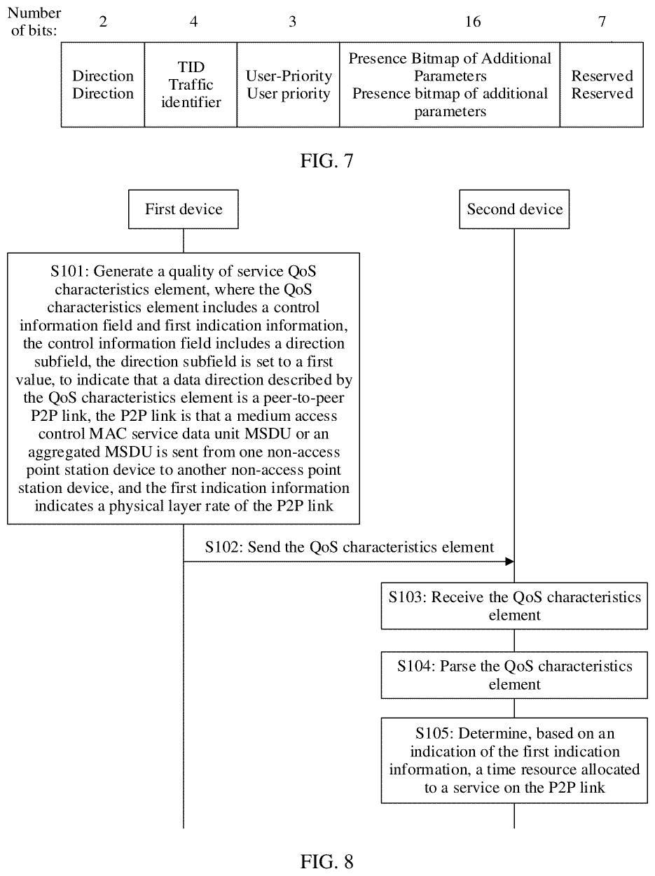

A frame format of the control information field is shown in FIG. 7. FIG. 7 is a schematic diagram of a frame format of a control information field according to an embodiment of the present disclosure. The control information field includes but is not limited to a direction subfield, a traffic identifier (TID) subfield, a user priority subfield, and a presence bitmap of additional parameters subfield. The direction subfield indicates a data direction described by the QoS characteristics element. When the direction subfield (length: 2 bits) is set to 00 (0 in decimal system), it indicates that the data direction described by the QoS characteristics element is an uplink (UL), that is, the data direction is that an MSDU or an A-MSDU is sent from a non-AP STA to an AP (MSDUs or A-MSDUs are sent from the non-AP STA to the AP). When the direction subfield is set to 01 (1 in decimal system), it indicates that the data direction described by the QoS characteristics element is a downlink (DL), that is, the data direction is that an MSDU or an A-MSDU is sent from an AP STA to a non-AP STA (MSDUs or A-MSDUs are sent from the AP to the non-AP STA). When the direction subfield is set to 10 (2 in decimal system), it indicates that the data direction described by the QoS characteristics element is a direct link (Direct link), that is, the data direction is that an MSDU or an A-MSDU is sent from a non-AP STA/non-AP MLD to another non-AP STA/non-AP MLD (MSDUs or A-MSDUs are sent from the non-AP STA/non-AP MLD to another non-AP STA/non-AP MLD). When the direction subfield is set to 11 (3 in decimal system), this field is reserved. The TID subfield contains a TID value of a data frame described by the QoS characteristics element (The TID subfield contains the TID value of the data frames that are described by this element). The TID subfield is set to the same value as the user priority subfield (The TID subfield is set to the same value as the User Priority subfield). Values 8 to 15 are reserved (The values 8˜15 are reserved). The user priority subfield includes user priority values (0 to 7) of a data frame described by the QoS characteristics element. The presence bitmap of additional parameters subfield includes a bitmap, and if an i^{th} field starting from the maximum MSDU size field is present in the QoS characteristics element, an i^{th} bit of the bitmap is set to 1.

The following describes some fields of the QoS characteristics element shown in FIG. 6. For values and meanings of the other fields, refer to the descriptions in the existing standard.

Minimum service interval field: If the direction subfield is set to 0 (uplink), the minimum service interval field contains an unsigned integer that specifies a minimum interval, in microseconds, between the start of two consecutive service periods that are allocated to a STA for UL frame exchanges, and a value 0 is reserved. (If the Direction subfield is set to 0 (Uplink), the Minimum Service Interval field contains an unsigned integer that specifies the minimum interval, in microseconds, between the start of two consecutive service periods that are allocated to the STA for UL frame exchanges and the value 0 is reserved.) If the direction subfield is set to 1 (downlink), the minimum service interval field contains an unsigned integer that specifies a minimum interval, in microseconds, between two consecutive service periods that are allocated for a DL frame exchange sequence, and a value 0 indicates that this parameter (namely, a minimum service interval) is unspecified. (If the Direction subfield is set to 1 (Downlink), the Minimum Service Interval field contains an unsigned integer that specifies the minimum interval, in microseconds, between the two consecutive service periods that are allocated for DL frame exchange sequences and the value 0 indicates that this parameter is unspecified.) If the direction subfield is set to 2 (Direct Link), the minimum service interval field contains an unsigned integer that specifies a minimum interval, in microseconds, between the start of two consecutive service periods that are allocated to a STA for direct link frame exchanges, and a value 0 is reserved. (If the Direction subfield is set to 2 (Direct link), the Minimum Service Interval field contains an unsigned integer that specifies the minimum interval, in microseconds, between the start of two consecutive service periods that are allocated to the STA for direct link frame exchanges and the value 0 is reserved.)

Maximum service interval field: If the direction subfield is set to 0 (uplink), the maximum service interval field contains an unsigned integer that specifies a maximum interval, in microseconds, between the start of two consecutive service periods that are allocated to a STA for UL frame exchanges, and a value 0 is reserved. If the direction subfield is set to 1 (downlink), the maximum service interval field contains an unsigned integer that specifies a maximum interval, in microseconds, between the two consecutive service periods that are allocated for a DL frame exchange sequence, and a value 0 indicates that this parameter (namely, a maximum service interval) is unspecified. If the direction subfield is set to 2 (Direct Link), the maximum service interval field contains an unsigned integer that specifies a maximum interval, in microseconds, between the start of two consecutive service periods that are allocated to a STA for direct link frame exchanges, and a value 0 is reserved. A value of the maximum service interval field is greater than or equal to a value of the minimum service interval field.

Minimum data rate field: The minimum data rate field contains an unsigned integer that specifies a lowest data rate specified at a MAC service access point (SAP), in Kbps (kilobits per second), for transport of an MSDU or an A-MSDU belonging to a traffic flow described by the QoS characteristics element. (The Minimum Data Rate field contains an unsigned integer that specifies the lowest data rate specified at the MAC SAP, in kbps, for transport of MSDUs or A-MSDUs belonging to the traffic flow described by this element.)

Mean data rate field: The mean data rate field indicates an average data rate specified at a MAC SAP, in Kbps, for transport of an MSDU or an A-MSDU belonging to a traffic flow within bounds of the QoS characteristics element. (The Mean Data Rate field indicates the average data rate specified at the MAC SAP, in kbps, for transport of MSDUs or A-MSDUs belonging to the traffic flow within the bounds of this element.)

Burst size field: The burst size field has a length of 4 octets and contains an unsigned integer that specifies the maximum burst, in octets, of an MSDU or an A-MSDU belonging to a traffic flow that arrives at a MAC SAP at a peak data rate. (The Burst Size field is 4 octets long and contains an unsigned integer that specifies the maximum burst, in octets, of the MSDUs or A-MSDUs belonging to the traffic flow that arrive at the MAC SAP at the peak data rate.)

Medium time field: The medium time field includes an unsigned integer that specifies medium time, in units of 256 microseconds per second, requested by a STA for direct link transmission as an average medium time needed in each second, assuming the STA uses the bandwidth indicated in the bandwidth field for the direct link transmission. This field is present if the direction subfield is set to 2 (Direct Link). (The Medium Time field contains an unsigned integer that specifies the medium time, in units of 256 microseconds per second, requested by the STA for direct link transmissions as the average medium time needed in each second, assuming the STA uses the bandwidth indicated in the Bandwidth field for direct link transmissions. This field is present if the Direction subfield is set to 2 (Direct link).)

Bandwidth field: The bandwidth field specifies the maximum bandwidth that a STA can operate for direct link transmission. This field is present if the direction subfield is set to 2 (Direct Link).

For uplink and downlink services, an AP allocates a time resource based on a parameter reported in a QoS characteristics element and a physical layer rate between the AP and a STA. However, for a P2P link (or direct link), the AP determines a size of an allocated time resource based on medium time, and cannot reuse uplink and downlink time allocation algorithms on an AP side.

Therefore, embodiments of the present disclosure provide an information indication method for a P2P link. A physical layer parameter (for example, a physical layer rate, a modulation and coding scheme, or a number of spatial streams) of the P2P link is directly reported through a QoS characteristics element. Therefore, an AP side can reuse uplink and downlink time allocation algorithms. Further, the present disclosure further provides a technical solution for extending a P2P link to a multi-link, to improve transmission efficiency/a throughput. In addition, according to the information indication method for a P2P link provided in embodiments of the present disclosure, a P2P link identifier is further carried in the QoS characteristics element, to identify a P2P link to which a traffic flow described by the element is mapped. Alternatively, it is restricted that a TID in the QoS characteristics element is unique, so that an AP can distinguish a P2P link that a service reported by a station is for.

The technical solutions provided in the present disclosure may be described by using a plurality of embodiments. For details, refer to the following descriptions. In the present disclosure, unless otherwise specified, for same or similar parts of embodiments or implementations, refer to each other. In embodiments of the present disclosure and the implementations/methods/implementation methods in embodiments, unless otherwise specified or a logical conflict occurs, terms and/or descriptions are consistent and may be mutually referenced between different embodiments and between the implementations/methods/implementation methods in embodiments. Technical features in the different embodiments and the implementations/methods/implementation methods in embodiments may be combined to form a new embodiment, implementation, method, or implementation method based on an internal logical relationship thereof. The following implementations of the present disclosure are not intended to limit the protection scope of the present disclosure.

Optionally, a first device in the present disclosure may be a STA (single-link) such as the STA 200 shown in FIG. 1 or the STA 1 shown in FIG. 5a, or may be a non-AP MLD such as the non-AP MLD 1 shown in FIG. 5b. A second device in the present disclosure may be an AP (single-link) such as the AP 100 shown in FIG. 1 or the AP 1 shown in FIG. 5a, or may be an AP MLD such as the AP MLD 1 shown in FIG. 5b. Both the first device and the second device in the present disclosure support the 802.11be protocol (or referred to as Wi-Fi 7, or an EHT protocol), and may further support other WLAN communication protocols such as the 802.11ax and the 802.11ac. It should be understood that the first device and the second device in the present disclosure may further support a future 802.11 protocol, for example Wi-Fi 8 and Wi-Fi 9. In other words, the method provided in the present disclosure is not only applicable to the 802.11be protocol, but also applicable to the future 802.11 protocol.

The following separately describes embodiments in detail.

### Embodiment 1

FIG. 8 is a first schematic flowchart of an information indication method for a P2P link according to an embodiment of the present disclosure. This mainly describes how a STA reports physical layer parameter indication information of a P2P link in a QoS characteristics element. As shown in FIG. 8, the information indication method for a P2P link includes but is not limited to the following steps.
S101: A first device generates a quality of service (QOS) characteristics element, where the QoS characteristics element includes a control information field and first indication information, the control information field includes a direction subfield, the direction subfield is set to a first value, to indicate that a data direction described by the QoS characteristics element is a peer-to-peer (P2P) link, the P2P link is that a medium access control (MAC) service data unit (MSDU) or an aggregated MSDU is sent from one non-access point station device to another non-access point station device, and the first indication information indicates a physical layer rate of the P2P link.
S102: The first device sends the QoS characteristics element.

Optionally, the first device in this embodiment is a STA (single-link) or a non-AP MLD. The first device generates the QoS characteristics element. The QoS characteristics element may be carried in a stream classification service (SCS) request frame. Certainly, the QoS characteristics element may alternatively be carried in another MAC frame. This is not limited in embodiments of the present disclosure. The first device sends the QoS characteristics element. In other words, the first device sends a frame that carries the QoS characteristics element. For example, the first device sends an SCS request frame, and the SCS request frame carries the QoS characteristics element. In addition, the QoS characteristics element in the present disclosure is merely an example, and the name should not be used as a limitation on a function of the QoS characteristics element. With the progress of the standard, there may be another name.

The QoS characteristics element includes but is not limited to the control information (control info) field and the first indication information. The control information field includes but is not limited to the direction subfield. The direction subfield is set to 2 (that is, the first value is 2 in decimal system and 10 in binary system), to indicate that the data direction described by the QoS characteristics element is the P2P link/a direct link, that is, the data direction is that data (for example, an MSDU or an A-MSDU) is sent from one non-access point station device to another non-access point station device. Herein, the non-access point station device may be the STA, or may be the non-AP MLD. In other words, the data direction is that the data is sent from one STA to another STA, or the data is sent from one non-AP MLD to another non-AP MLD. The first indication information may indicate a physical layer rate of the P2P link/direct link. The first indication information may include but is not limited to one or more of the following: a physical layer rate, a modulation and coding scheme (MCS), and a number of spatial streams (NSS).

The following describes implementations of the first indication information.

1. The first device is the single-link STA.

When the first device is the single-link STA, the P2P link/direct link described by the foregoing QoS characteristics element is mapped to a physical link (or a physical channel, or a frequency band). In other words, when the first device is the single-link STA, a P2P service described by the foregoing QoS characteristics element is transmitted on a physical link (or a physical channel, or a frequency band).

### Implementation 1.1:

The first indication information may be the physical layer rate of the P2P link/direct link. In other words, the first indication information directly indicates the physical layer rate of the P2P link/direct link.

The physical layer rate may be in a unit of Mbps (megabit per second). The first indication information may be a field in the QoS characteristics element, for example, a physical layer rate of P2P link (PHY Rate of P2P link) field. Certainly, the first indication information may also have another name. This is not limited in embodiments of the present disclosure.

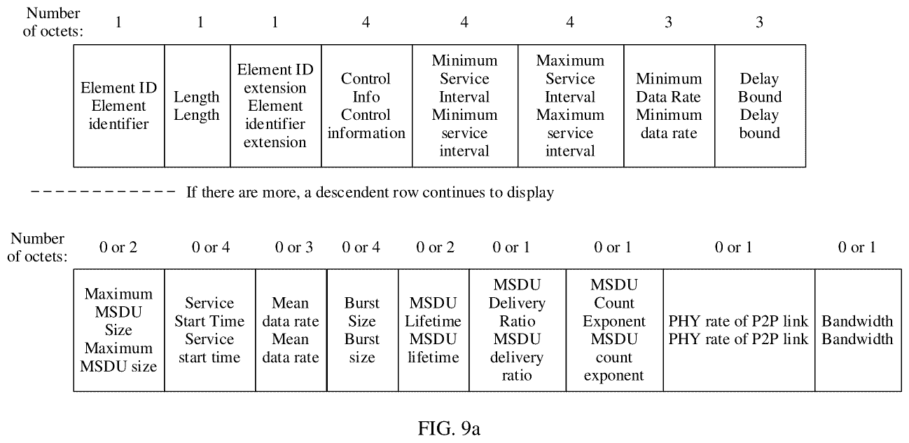

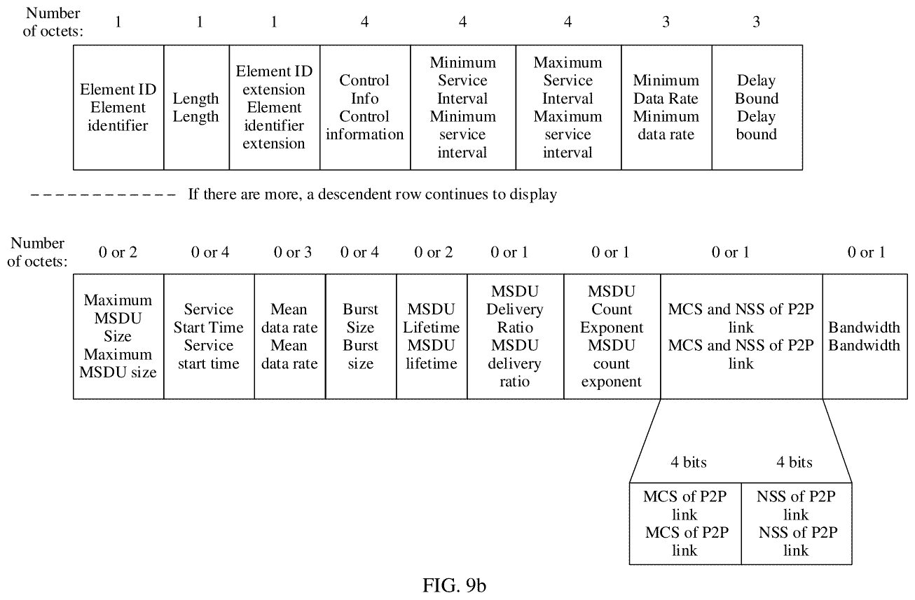

FIG. 9a is a schematic diagram of a frame format of first indication information in a QoS characteristics element according to an embodiment of the present disclosure. As shown in FIG. 9a, the QoS characteristics element includes but is not limited to a control information (control info) field and a PHY rate of P2P link field (namely, the foregoing first indication information). For a frame format of the control information (control info) field, refer to FIG. 7. When a direction subfield in the control information field is set to 2, the PHY rate of P2P link field is present. When the PHY rate of P2P link field is present in the QoS characteristics element, the PHY rate of P2P link field (whose length is 1 octet, namely, 8 bits) indicates a physical layer rate of a P2P link/direct link. Values of physical layer rates indicated by the PHY rate of P2P link field may be linear, piecewise linear, or one-to-one mapping. In an example, linear indication: The PHY rate of P2P link field has eight bits, and when a value of the PHY rate of P2P link field is k, an indicated physical layer rate is equal to (k+1)*10 Mbps. The PHY rate of P2P link field may indicate rates in a range of 10 Mbps to 2560 Mbps in total. In another example, piecewise linear indication: The PHY rate of P2P link field has eight bits, and when a value is greater than or equal to 0 and less than 128 (that is, 0≤k<128), an indicated physical layer rate is equal to (k+1)*1 Mbps. When a value is greater than or equal to 128 and less than 255 (that is, 128≤k<255), an indicated physical layer rate is equal to (k−127)*10 Mbps+128 Mbps. In still another example, one-to-one mapping indication: Possible physical layer rates are obtained based on parameters such as an MCS, a number of spatial streams, and a bandwidth that are supported by a physical layer, and then are one-to-one mapped to values of the PHY rate of P2P link field in ascending or descending order.

For example, as shown in FIG. 9a, the PHY rate of P2P link field may replace a medium time field in the QoS characteristics element. In this way, an AP side may reuse uplink and downlink time allocation algorithms without increasing bit overheads, and information redundancy can be reduced, that is, both medium time and the physical layer rate are reported, but the AP side uses only one of the medium time and the physical layer rate to allocate time resources. Certainly, the PHY rate of P2P link field may alternatively be a newly added field in the QoS characteristics element. This is not limited in embodiments of the present disclosure.

In the implementation 1.1, the physical layer rate is calculated on a station side and reported to the AP side, so that the AP side can obtain a more accurate physical layer rate. This is because the station side learns of physical layer parameters of a P2P link set up between the station side and another device, such as an MCS, an NSS, a bandwidth, a padding length, and a cyclic prefix (CP) length. These physical layer parameters may be used to calculate the physical layer rate.

### Implementation 1.2:

The first indication information may be the modulation and coding scheme (MCS) and the number of spatial streams (NSS) of the P2P link/direct link. In other words, the first indication information indirectly indicates the physical layer rate of the P2P link/direct link. Because the MCS and the NSS are main parameters that affect the physical layer rate, a second device (AP or AP MLD) may determine the physical layer rate after receiving the MCS and the NSS that are reported by the first device. Optionally, the first indication information may further include another parameter that may be used to determine the physical layer rate, for example, a padding length or a cyclic prefix (CP) length. This is not limited in embodiments of the present disclosure.

The physical layer rate may be in a unit of Mbps (megabit per second). The first indication information may be a field in the QoS characteristics element, for example, an MCS and NSS of P2P link (MCS and NSS of P2P link) field. Certainly, the first indication information may also have another name. This is not limited in embodiments of the present disclosure.

FIG. 9b is a schematic diagram of another frame format of first indication information in a QoS characteristics element according to an embodiment of the present disclosure. As shown in FIG. 9b, the QoS characteristics element includes but is not limited to a control information (control info) field and an MCS and NSS of P2P link field (namely, the foregoing first indication information). For a frame format of the control information (control info) field, refer to FIG. 7. When a direction subfield in the control information field is set to 2, the MCS and NSS of P2P link field is present. The MCS and NSS of P2P link field (whose length is 1 octet, namely, 8 bits) includes an MCS of P2P link subfield and an NSS of P2P link subfield, where the MCS of P2P link subfield and the NSS of P2P link subfield each occupy four bits. The MCS of P2P link subfield indicates an MCS value of a P2P link/direct link, and the NSS of P2P link subfield indicates an NSS supported by the P2P link/direct link. The NSS of P2P link subfield is set to a number of spatial streams that may be supported by the P2P link/direct link minus 1. For example, if the number of spatial streams that may be supported by the P2P link/direct link is 1, the NSS of P2P link subfield is set to 0. If the number of spatial streams that may be supported by the P2P link/direct link is 2, the NSS of P2P link subfield is set to 1. If the number of spatial streams that may be supported by the P2P link/direct link is 3, the NSS of P2P link subfield is set to 2. The rest may be deduced by analogy.

For example, as shown in FIG. 9b, the MCS and NSS of P2P link field may replace a medium time field in the QoS characteristics element. Certainly, the MCS and NSS of P2P link field may alternatively be a newly added field in the QoS characteristics element. This is not limited in embodiments of the present disclosure.

In the implementation 1.2, main parameters, namely, the MCS and the NSS, used for determining the physical layer rate are reported, so that an AP side determines the physical layer rate based on the MCS and the NSS, to reduce complexity on a station side.

It should be understood that the last two fields (namely, the Medium Time field and the Bandwidth field) in the QoS characteristics element are used only for a service on the P2P link, and all other fields in the QoS characteristics element may be used for services on a downlink (DL), an uplink (UL), and the P2P link. The downlink and uplink services do not need medium time information and bandwidth information because an AP can already learn of a rate (particularly depending on parameters such as an MCS, a number of spatial streams, and a bandwidth) reachable by a physical layer link. Therefore, the AP may obtain, through calculation with reference to the rate of the physical layer link, transmission time that needs to be allocated to a service reported by a station. On the P2P link, a station communicates with another station, and the AP cannot obtain information about the physical layer rate of the P2P link.

Therefore, in this embodiment, the station side directly reports the physical layer rate of the P2P link by adding the PHY rate of P2P link field to the QoS characteristics element, or the MCS and NSS of P2P Link field is carried to report the MCS and NSS that are used to determine the physical layer rate. Therefore, the AP side can obtain, through calculation based on the physical layer parameter (the physical layer rate, or the MCS and the NSS) reported by the station, transmission time required by a service reported on the P2P link, and further, the AP side can reuse the uplink and downlink time allocation algorithms.

2. The first device is the non-AP MLD.

When the first device is the non-AP MLD, the P2P link/direct link described by the foregoing QoS characteristics element may be mapped to one or more physical links (or a physical channel, or a frequency band). In other words, when the first device is the non-AP MLD, the P2P link/direct link described by the foregoing QoS characteristics element may be mapped to at least one of multiple links (ML). In other words, when the first device is the non-AP MLD, a P2P service described by the foregoing QoS characteristics element may be transmitted on at least one of multiple links. The multiple links herein may be a plurality of links set up between the first device (the non-AP MLD) and another non-AP MLD. FIG. 5b is used as an example. It is assumed that the first device is the non-AP MLD 1, the P2P link 4 is set up between the non-AP MLD 1 and the non-AP MLD3, and a P2P link described by a QoS characteristics element reported by the non-AP MLD 1 is the P2P link 4. In this case, the P2P link 4 may be mapped to either of the link L1 and the link L3, or a P2P service between the non-AP MLD 1 and the non-AP MLD 3 may be transmitted on either of the link L1 and the link L3.

Because the P2P service may be transmitted on a multi-link (ML), a physical layer rate of each link needs to be indicated.

### Implementation 2.1:

The QOS characteristics element further includes second indication information, and the second indication information may indicate that at least one of multiple links is used as the P2P link/direct link described by the QoS characteristics element. Alternatively, the second indication information may indicate at least one link to which the P2P link/direct link described by the QoS characteristics element in multiple links is mapped.

In an implementation, the second indication information may be present in a form of a bitmap, and one bit of the second indication information corresponds to one link. When one bit of the second indication information is set to a second value (for example, 1), it indicates that a link corresponding to the bit is used as the P2P link described by the QoS characteristics element, or indicates that the P2P link/direct link described by the QoS characteristics element is mapped to a link corresponding to the bit. FIG. 5b is used as an example. It is assumed that the first device is the non-AP MLD 1, the P2P link 4 is set up between the non-AP MLD 1 and the non-AP MLD 3, and the P2P link described by the QoS characteristics element reported by the non-AP MLD 1 is the P2P link 4. The second indication information has four bits that correspond to the links L1, L2, L3, and L4 respectively. When the second indication information is 1010, it indicates that L1 and L3 in the links L1, L2, L3, and L4 are used as P2P links 4, that the P2P links 4 are mapped to the links L1 and L3, or that the P2P service between the non-AP MLD 1 and the non-AP MLD 3 is transmitted on the links L1 and L3. It should be understood that a length of the second indication information exemplified herein is 4 bits. However, in actual application, the length of the second indication information may be greater than 4 bits, for example, 16 bits (2 octets), and one bit corresponds to one link. Certainly, the length may alternatively be less than 4 bits. This is not limited in embodiments of the present disclosure.

If n bits in the second indication information are all set to the second value (for example, 1), that is, the second indication information indicates that n links in the multiple links are used as P2P links/direct links described by the QOS characteristics element, the QOS characteristics element includes n pieces of first indication information and n bandwidth fields. n is a positive integer. One piece of first indication information may be a physical layer rate of one of the n links, that is, the piece of first indication information directly indicates the physical layer rate of the link. One bandwidth field may indicate a maximum bandwidth for transmission on one of the n links. In other words, if n bits in the second indication information are all set to a second value (for example, 1), n pieces of first indication information and n bandwidth fields are required in the QoS characteristics element to indicate physical layer rates of the n links and maximum transmission bandwidths of the n links.

The physical layer rate may be in a unit of Mbps. The second indication information may be a field in the QoS characteristics element, for example, an ML bitmap for P2P (ML bitmap for P2P) field or an ML bitmap for P2P link (ML bitmap for P2P link) field. Certainly, the second indication information may also have another name. This is not limited in embodiments of the present disclosure. Alternatively, the first indication information may be a field in the QoS characteristics element, for example, a physical layer rate of link (PHY Rate of link) field. Certainly, the first indication information may also have another name. This is not limited in embodiments of the present disclosure.

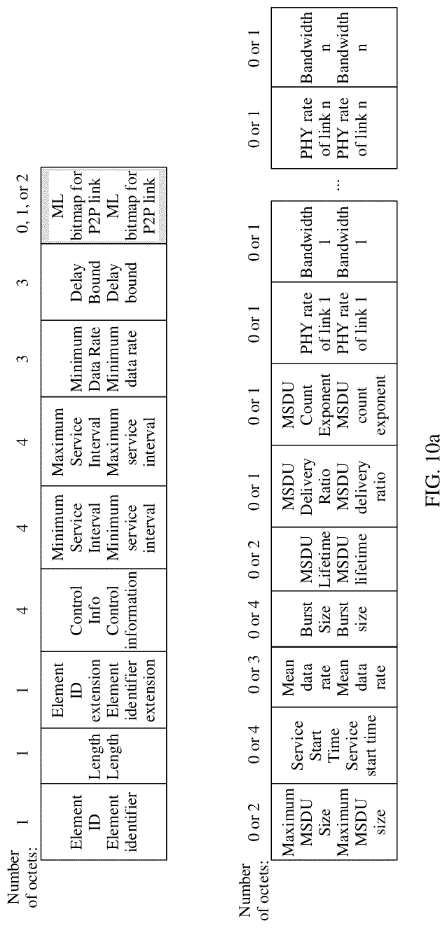

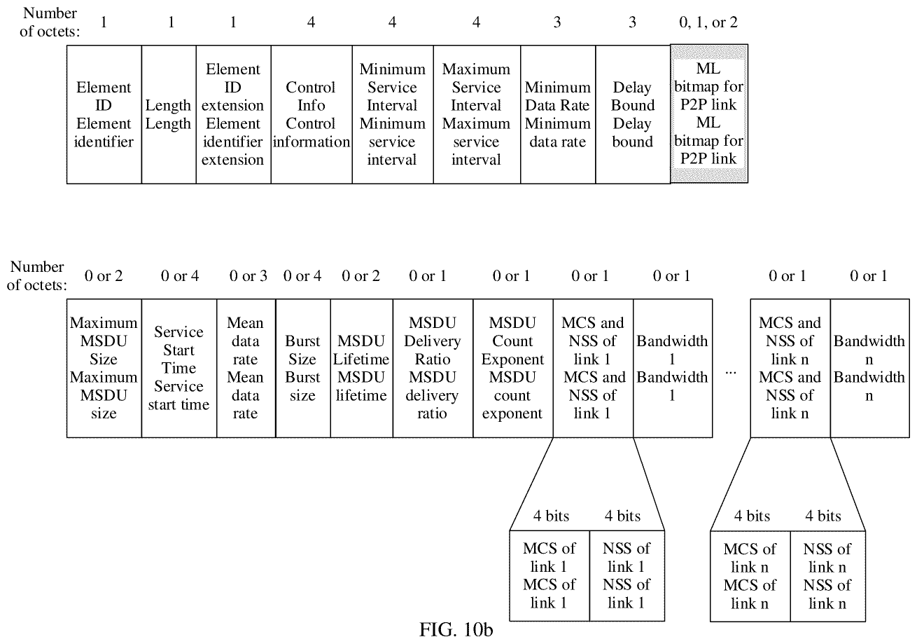

FIG. 10a is a schematic diagram of a frame format of first indication information and a frame format of second indication information in a QoS characteristics element according to an embodiment of the present disclosure. As shown in FIG. 10a, the QoS characteristics element includes but is not limited to a control information (control info) field, an ML bitmap for P2P link field (namely, the foregoing second indication information), and one or more PHY rate of link fields (namely, the foregoing first indication information). For a frame format of the control information (control info) field, refer to FIG. 7. When a direction subfield in the control information field is set to 2, the ML bitmap for P2P link field is present. When the ML bitmap for P2P link field is present in the QoS characteristics element, a length of the ML bitmap for P2P link field is 1 octet or 2 octets. One bit corresponds to one link. A link ID of the link is allocated by an AP MLD associated with the link (namely, the first device). If a bit in the ML bitmap for P2P link field is set to 1, it indicates that the P2P link/direct link described by the QoS characteristics element is mapped to a link corresponding to the bit. If a bit in the ML bitmap for P2P link field is set to 0, it indicates that the P2P link/direct link described by the QoS characteristics element is not mapped to a link corresponding to the bit. When n bits in the ML bitmap for P2P link field are set to 1, the QoS characteristics element includes n PHY rate of link fields and n bandwidth fields. n is a positive integer. One PHY rate of link field indicates a physical layer rate of a link corresponding to a bit that is set to 1 in the ML bitmap for P2P link field. Similarly, one bandwidth field indicates a maximum bandwidth for transmission on a link corresponding to a bit that is set to 1 in the ML bitmap for P2P link field.

For example, values of physical layer rates indicated by the PHY rate of link field may be linear, piecewise linear, or one-to-one mapping. For details, refer to the foregoing descriptions.

### Implementation 2.2:

The QOS characteristics element further includes second indication information, and the second indication information may indicate that at least one of multiple links is used as the P2P link/direct link described by the QOS characteristics element. Alternatively, the second indication information may indicate at least one link to which the P2P link/direct link described by the QoS characteristics element in multiple links is mapped. The second indication information may be present in a form of a bitmap, and one bit of the second indication information corresponds to one link. When one bit of the second indication information is set to a second value (for example, 1), it indicates that a link corresponding to the bit is used as the P2P link described by the QoS characteristics element, or indicates that the P2P link/direct link described by the QoS characteristics element is mapped to a link corresponding to the bit.

If n bits in the second indication information are all set to the second value (for example, 1), that is, the second indication information indicates that a number of links to which P2P links/direct links described by the QoS characteristics element are mapped is n, the QoS characteristics element includes n pieces of first indication information and n bandwidth fields. n is a positive integer. One piece of first indication information may be an MCS and an NSS of one of the n links, that is, the piece of first indication information indirectly indicates a physical layer rate of the link. One bandwidth field may indicate a maximum bandwidth for transmission on one of the n links. In other words, if n bits in the second indication information are all set to the second value (for example, 1), n pieces of first indication information and n bandwidth fields are required in the QoS characteristics element to indicate MCSs and NSSs of the n links and maximum transmission bandwidths of the n links.

The physical layer rate may be in a unit of Mbps. The second indication information may be a field in the QoS characteristics element, for example, an ML bitmap for P2P field or an ML bitmap for P2P link field. Certainly, the second indication information may also have another name. This is not limited in embodiments of the present disclosure. Alternatively, the first indication information may be a field in the QOS characteristics element, for example, an MCS and NSS of link field. Certainly, the first indication information may also have another name. This is not limited in embodiments of the present disclosure.

FIG. 10b is a schematic diagram of another frame format of first indication information and another frame format of second indication information in a QoS characteristics element according to an embodiment of the present disclosure. As shown in FIG. 10b, the QoS characteristics element includes but is not limited to a control information (control info) field, an ML bitmap for P2P link field (namely, the foregoing second indication information), and one or more MCS and NSS of link fields (namely, the foregoing first indication information). For a frame format of the control information (control info) field, refer to FIG. 7. When a direction subfield in the control information field is set to 2, the ML bitmap for P2P link field is present. When the ML bitmap for P2P link field is present in the QoS characteristics element, a length of the ML bitmap for P2P link field is 1 octet or 2 octets. One bit corresponds to one link. A link ID of the link is allocated by an AP MLD associated with the link (namely, the first device). If a bit in the ML bitmap for P2P link field is set to 1, it indicates that the P2P link/direct link described by the QoS characteristics element is mapped to a link corresponding to the bit. If a bit in the ML bitmap for P2P link field is set to 0, it indicates that the P2P link/direct link described by the QoS characteristics element is not mapped to a link corresponding to the bit. When n bits in the ML bitmap for P2P link field are set to 1, the QoS characteristics element includes n MCS and NSS of link fields and n bandwidth fields. n is a positive integer. One MCS and NSS of link field includes two subfields: an MCS of link subfield and an NSS of link subfield. The MCS of link subfield indicates an MCS value of a link corresponding to a bit that is set to 1 in the ML bitmap for P2P link field. The NSS of link subfield indicates an NSS supported by a link corresponding to a bit that is set to 1 in the ML bitmap for P2P link field. The NSS of link subfield is set to a number of spatial streams that may be supported by the P2P link/direct link minus 1. Similarly, one bandwidth field indicates a maximum bandwidth for transmission on a link corresponding to a bit that is set to 1 in the ML bitmap for P2P link field.

It should be understood that, if the P2P link is directly extended to the multi-link, data of the P2P link may be transmitted through the multiple links. When resources are requested by the multiple links, how total required time is allocated on the multiple links needs to be further considered. Therefore, in a conventional technology, direct extension to the multi-link cannot be implemented.

Therefore, in this embodiment, the second indication information is added to the QoS characteristics element, to indicate that at least one of the multiple links is used as the P2P link/direct link described by the QoS characteristics element. In addition, correspondingly, an indication manner of the first indication information is designed, that is, a physical layer rate of each link indicated by the second indication information is indicated. In this way, an AP side can reuse uplink and downlink time allocation algorithms, and the P2P link/direct link is extended to MLDs, so that advantages of the multi-link are used, to improve transmission efficiency/a throughput of the P2P service and further reduce latency.

Optionally, the QoS characteristics element may further include third indication information, and the third indication information may indicate a mean service interval allocated to the first device for frame exchange on the P2P link/direct link. The third indication information may be a newly added field in the QoS characteristics element, for example, a mean service interval field. Certainly, the third indication information may also have another name. This is not limited in embodiments of the present disclosure.

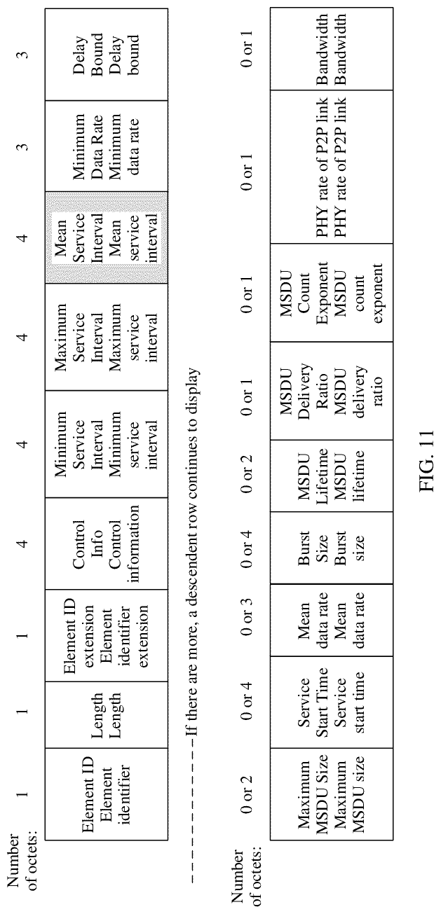

FIG. 11 is a schematic diagram of a frame format of third indication information in a QoS characteristics element according to an embodiment of the present disclosure. That first indication information in the QoS characteristics element is that in FIG. 9a is used as an example. As shown in FIG. 11, the QoS characteristics element includes but is not limited to a control information (control info) field, a mean service interval field (namely, the foregoing third indication information), and a PHY rate of P2P link field (namely, the foregoing first indication information). The mean service interval field has a length of 4 octets, and indicates an average length of service intervals. For meanings of the control information (control info) field and the PHY rate of P2P link field, refer to the foregoing descriptions.

In this embodiment, the mean service interval field (namely, the third indication information) is added to the QoS characteristics element, to indicate the mean service interval allocated to the first device for frame exchange on the P2P link/direct link, so as to refine a time resource allocation manner.

Optionally, the QoS characteristics element may further include fifth indication information, and the fifth indication information may indicate a P2P link/direct link to which a traffic flow (or a P2P service) described by the QoS characteristics element is mapped. The fifth indication information may be a newly added field in the QoS characteristics element, for example, a P2P link identifier field. Certainly, the fifth indication information may also have another name. This is not limited in embodiments of the present disclosure.

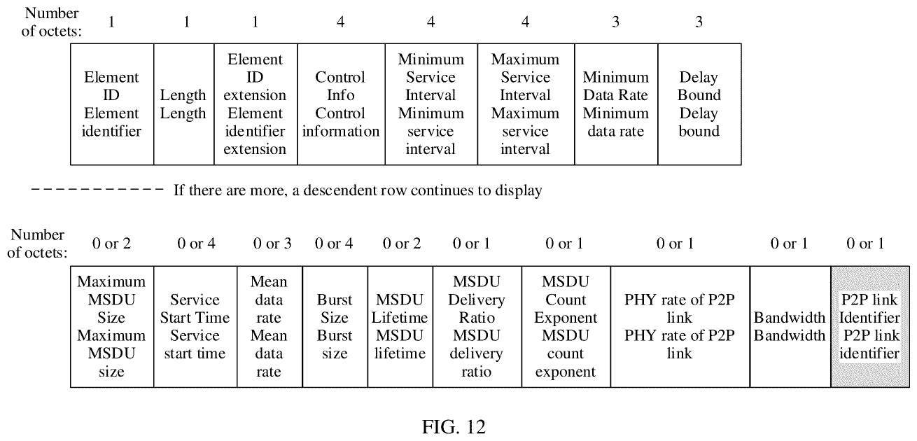

FIG. 12 is a schematic diagram of a frame format of fifth indication information in a QOS characteristics element according to an embodiment of the present disclosure. That first indication information in the QoS characteristics element is that in FIG. 9a is used as an example. As shown in FIG. 12, the QoS characteristics element includes but is not limited to a control information (control info) field, a P2P link identifier field (namely, the foregoing fifth indication information), and a PHY rate of P2P link field (namely, the foregoing first indication information). When a direction subfield in the control information field is set to 2, the P2P link identifier field is present. The P2P link identifier field may occupy four bits in one octet (namely, eight bits), and each value corresponds to a unique P2P link. An identifier value of the P2P link may be determined by a station. For meanings of the control information (control info) field and the PHY rate of P2P link field, refer to the foregoing descriptions.

It should be understood that, when the first device is the non-AP MLD, although the P2P link is mapped to the multi-link (or the P2P service is transmitted on the multi-link), there is only one P2P link between one non-AP MLD and another non-AP MLD. Therefore, there is only one P2P link identifier field in the QoS characteristics element.

Optionally, the control information field may further include a TID subfield, and a TID value indicated by the TID subfield is different from a TID value corresponding to any service on a P2P link set up between the first device and another device. In other words, when establishing a service, the first device allocates a unique TID to any service on a plurality of P2P links. FIG. 5a is used as an example. It is assumed that the first device is the STA 1. If a TID corresponding to a service on the P2P link 1 set up between the STA 1 and the STA 2 is 0, a TID corresponding to a service on the P2P link 2 set up between the STA 1 and the STA 3 cannot be 0, but is another value, for example, 1.

Alternatively, a TID value indicated by the TID subfield is different from a TID value corresponding to a traffic flow on a P2P link that is historically reported by the first device based on the QoS characteristics element. In other words, the first device allocates a unique TID to a service that needs to be reported. A TID corresponding to a service that does not need to be reported may be reused on different P2P links. FIG. 5a is used as an example. It is assumed that the first device is the STA 1. If a service on the P2P link 1 set up between the STA 1 and the STA 2 needs to be reported based on the QoS characteristics element, and a TID corresponding to the service is 0, a TID corresponding to a service that needs to be reported on the P2P link 2 set up between the STA 1 and the STA 3 cannot be 0, but is another value, for example, 1.

In this embodiment, the P2P link identifier field (namely, the fifth indication information) is carried in the QoS characteristics element, to indicate the P2P link/direct link to which the traffic flow described by the QoS characteristics element is mapped, or restrict that a TID of a P2P service reported in the QoS characteristics element is unique, so that the AP side can distinguish a P2P link that a P2P traffic flow reported by a station side is for, thereby avoiding causing confusion to the AP side.
S103: A second device receives the QoS characteristics element.
S104: The second device parses the QoS characteristics element.
S105: The second device determines, based on an indication of the first indication information, a time resource allocated to a service on the P2P link.

Optionally, the second device in this embodiment is an AP (single-link) or an AP MLD. After receiving the QoS characteristics element, the second device parses the QoS characteristics element to obtain the first indication information. When the first indication information is the physical layer rate, the second device may determine, based on the physical layer rate, the time resource allocated to the service on the P2P link. For a specific allocation manner, refer to the uplink and downlink time allocation algorithms. The second device may determine the physical layer rate based on an MCS value and the NSS when the first indication information is the MCS and the NSS, and determines, based on the determined physical layer rate, the time resource allocated to the service on the P2P link.

Specifically, how to allocate time resources based on the physical layer rate may be implemented by using different algorithms, and the following is an example for description. It should be understood that, in actual application, another algorithm may alternatively be used for implementation. This is not limited in embodiments of the present disclosure. A service interval subfield specifies a time interval (which may specifically be one of a minimum service interval, a maximum service interval, and a mean service interval, or obtained by performing an operation on at least one of a minimum service interval, a maximum service interval, and a mean service interval) between start moments of two consecutive service periods. A mean data rate subfield specifies an average data rate. For uplink and downlink services, the physical layer rate is obtained by the AP based on historical data transmission or through channel measurement. For a P2P service, the physical layer rate is obtained based on a physical layer rate that is of the P2P link and that is reported in this embodiment. Time is allocated once at each service interval. A length of time allocated each time is: Service Interval*Mean Data Rate/physical layer rate of the P2P link.

Optionally, if the QOS characteristics element further includes the third indication information, after receiving the QoS characteristics element, the second device may determine, based on an indication of the third indication information, an interval at which the time resource is allocated to the first device once, and a size of the time resource allocated each time may be determined based on the first indication information. In other words, the second device may allocate the time resource to the first device once at intervals of a time length indicated by the third indication information, and a size of the time resource allocated each time may be determined based on the physical layer rate.

In this embodiment, the first indication information is carried in the QoS characteristics element to indicate the physical layer rate of the P2P link, so that the AP can obtain, through calculation based on the physical layer rate, transmission time required by the service reported on the P2P link, and further, the AP side can reuse the uplink and downlink time allocation algorithms. In addition, the P2P link is extended to the multi-link, to improve the transmission efficiency/throughput. In addition, in this embodiment, the third indication information is carried in the QoS characteristics element to indicate the interval at which the time resource is allocated to the first device once, so as to refine the time resource allocation manner. In this embodiment, the fifth indication information is carried in the QoS characteristics element to indicate the P2P link that the reported P2P traffic flow is for, or restrict that the TID in the QoS characteristics element is unique, so that the AP side can distinguish the P2P link that the P2P traffic flow reported by the station side is for, thereby avoiding causing confusion to the AP side.

### Embodiment 2

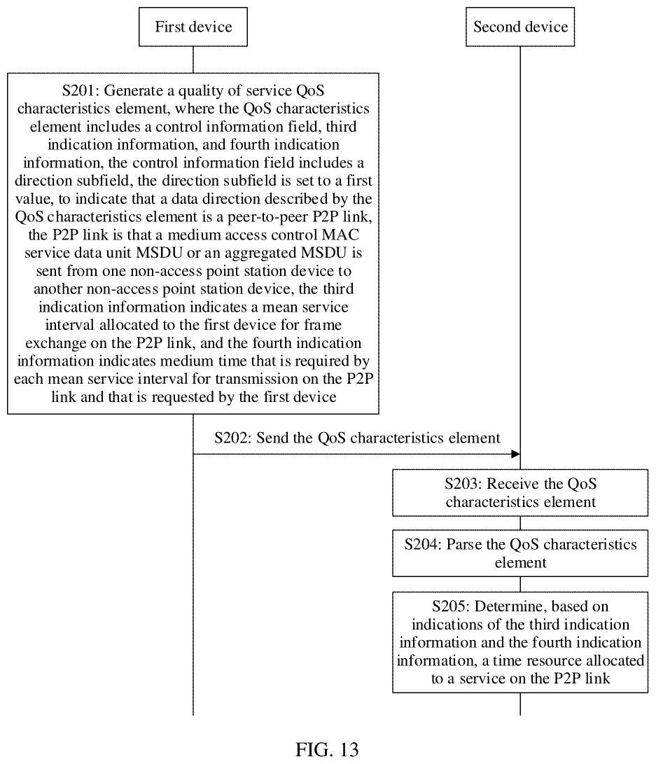

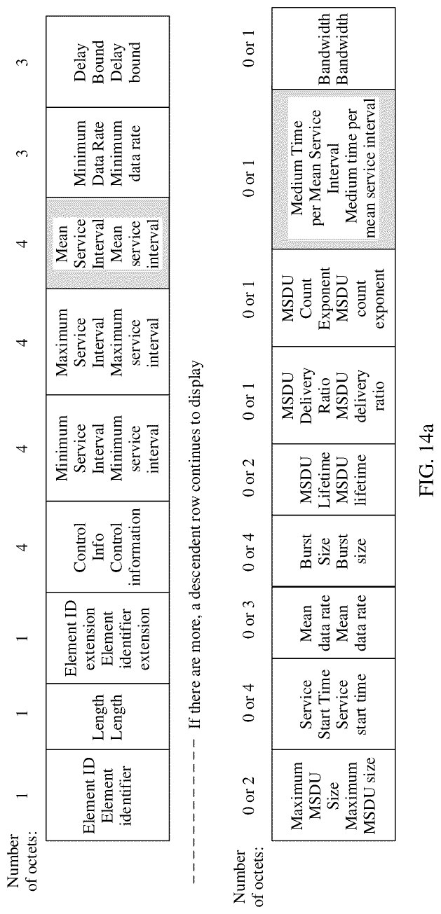

FIG. 13 is a second schematic flowchart of an information indication method for a P2P link according to an embodiment of the present disclosure. This mainly describes how a STA reports a mean service interval of a P2P link and a length of medium time required by each mean service interval in a QoS characteristics element. As shown in FIG. 13, the information indication method for a P2P link includes but is not limited to the following steps.
S201: A first device generates a quality of service (QOS) characteristics element, where the QoS characteristics element includes a control information field, third indication information, and fourth indication information, the control information field includes a direction subfield, the direction subfield is set to a first value, to indicate that a data direction described by the QoS characteristics element is a peer-to-peer (P2P) link, the P2P link is that a medium access control (MAC) service data unit (MSDU) or an aggregated MSDU is sent from one non-access point station device to another non-access point station device, the third indication information indicates a mean service interval allocated to the first device for frame exchange on the P2P link, and the fourth indication information indicates medium time that is required by each mean service interval for transmission on the P2P link and that is requested by the first device.
S202: The first device sends the QoS characteristics element.

Optionally, the first device in this embodiment is a STA (single-link) or a non-AP MLD. The first device generates the QoS characteristics element. The QoS characteristics element may be carried in an SCS request frame. Certainly, the QoS characteristics element may alternatively be carried in another MAC frame. This is not limited in embodiments of this application. The first device sends the QoS characteristics element. In other words, the first device sends a frame that carries the QoS characteristics element. For example, the first device sends an SCS request frame, and the SCS request frame carries the QoS characteristics element.

The QoS characteristics element includes but is not limited to the control information (control info) field, the third indication information, and the fourth indication information. The control information field includes but is not limited to the direction subfield. The direction subfield is set to 2 (that is, the first value is 2 in decimal system and 10 in binary system), to indicate that the data direction described by the QoS characteristics element is the P2P link/a direct link, that is, the data direction is that data (for example, an MSDU or an A-MSDU) is sent from one non-access point station device to another non-access point station device. Herein, the non-access point station device may be a STA, or may be a non-AP MLD. In other words, the data direction is that the data is sent from one STA to another STA, or the data is sent from one non-AP MLD to another non-AP MLD. The third indication information may indicate a mean service interval allocated to the first device for frame exchange on the P2P link/direct link. The fourth indication information may indicate a length of medium time that is required by each mean service interval for transmission on the P2P link/direct link and that is requested by the first device.

The following describes implementations of the third indication information and the fourth indication information.

### Implementation 3.1

When the first device is the single-link STA, the P2P link/direct link described by the foregoing QoS characteristics element is mapped to a physical link (or a physical channel, or a frequency band). In other words, when the first device is the single-link STA, a P2P service described by the foregoing QoS characteristics element is transmitted on a physical link (or a physical channel, or a frequency band).

The third indication information may indicate the mean service interval allocated to the first device for frame exchange on the P2P link/direct link, or indicate an average length of two consecutive service intervals allocated to the first device for frame exchange on the P2P link/direct link, or indicate an average length of service intervals. In other words, the third indication information indicates an interval at which a time resource is allocated to the first device once. The fourth indication information may indicate the length of the medium time that is required by each mean service interval for transmission on the P2P link/direct link and that is requested by the first device. In other words, the fourth indication information indicates a size of a time resource allocated to the first device each time.

The third indication information may be a newly added field in the QoS characteristics element, for example, a mean service interval field. Certainly, the third indication information may also have another name. This is not limited in embodiments of the present disclosure. The fourth indication information may be a field in the QoS characteristics element, for example, a medium time per mean service interval field. Certainly, the fourth indication information may also have another name. This is not limited in embodiments of the present disclosure.

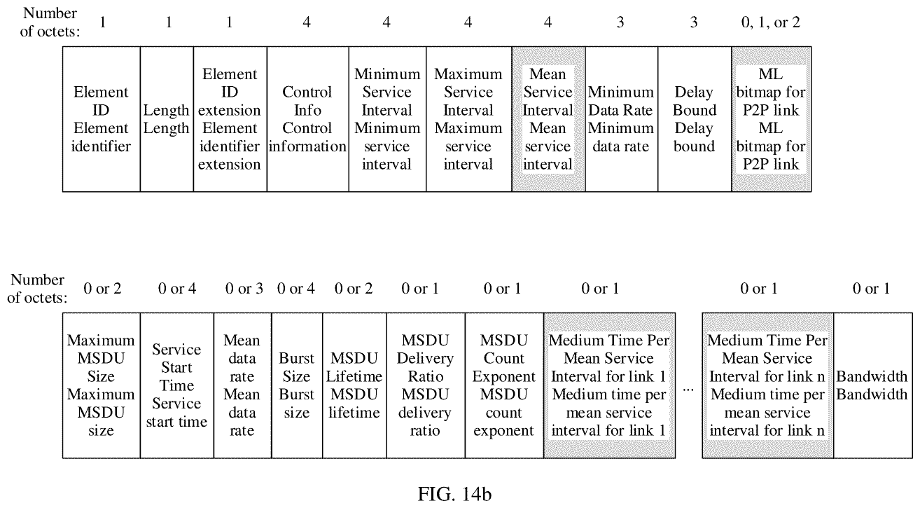

FIG. 14a is a schematic diagram of a frame format of third indication information and a frame format of fourth indication information according to an embodiment of the present disclosure. As shown in FIG. 14a, a QoS characteristics element includes but is not limited to a control information (control info) field, a mean service interval field (namely, the foregoing third indication information), and a medium time per mean service interval field (namely, the foregoing fourth indication information). For a frame format of the control information field, refer to FIG. 7. The mean service interval field has a length of 4 octets and includes an unsigned integer that specifies an average length of two consecutive service intervals that are allocated to a STA for frame exchange on a P2P link/direct link. When a direction subfield in the control information field is set to 2, the medium time per mean service interval field is present. When the medium time per mean service interval field is present in the QoS characteristics element, the medium time per mean service interval field has a length of 1 octet, namely, 8 bits, and includes an unsigned integer that specifies medium time requested by a STA for transmission on a P2P link/direct link as a length of medium time required by each mean service interval.

For example, as shown in FIG. 14a, the medium time per mean service interval field may replace a medium time field in the QoS characteristics element. In other words, in this embodiment, medium time is changed from a total time length required in each second to the length of the medium time required by each mean service interval. In this way, an AP side may reuse uplink and downlink time allocation algorithms without increasing bit overheads, and information redundancy can be reduced.

It should be understood that the QoS characteristics element includes the medium time field for the P2P service, and the field is a time length that a station requests an AP to allocate to the station in each second. It provides the total time length required in each second, but does not provide how to allocate time resources, for example, a number of parts into which the time resources are divided, and a length of each time resource.

Therefore, in this embodiment, the medium time in the QoS characteristics element is changed from the total time length required in each second to the length of the medium time required by each mean service interval, and the mean service interval field is added to indicate the average length of the service intervals. A time resource allocation manner may be refined, so as to determine an interval at which the AP allocates a time resource to the STA once and a length of a time resource allocated each time.

### Implementation 3.2

When the first device is the non-AP MLD, the P2P link/direct link described by the foregoing QoS characteristics element may be mapped to one or more physical links (or a physical channel, or a frequency band). In other words, the P2P link/direct link described by the foregoing QoS characteristics element may be mapped to at least one of multiple links (ML). In other words, a P2P service described by the foregoing QoS characteristics element may be transmitted on at least one of multiple links. The multiple links herein may be a plurality of links set up between the first device (the non-AP MLD) and another non-AP MLD. FIG. 5b is used as an example. It is assumed that the first device is the non-AP MLD 1, the P2P link 3 is set up between the non-AP MLD 1 and the non-AP MLD 2, and a P2P link described by a QoS characteristics element reported by the non-AP MLD 1 is the P2P link 3. In this case, the P2P link 3 may be mapped to either of the link L1 and the link L2, or a P2P service between the non-AP MLD 1 and the non-AP MLD 2 may be transmitted on either of the link L1 and the link L2.

Because the P2P service may be transmitted on a multi-link (ML), a length of medium time required by each mean service interval for transmission on each link needs to be indicated. Therefore, the QoS characteristics element further includes second indication information. For a specific implementation of the second indication information, refer to the corresponding descriptions in Embodiment 1.

If n bits in the second indication information are all set to a second value (for example, 1), that is, the second indication information indicates that n links in the multiple links are used as P2P links/direct links described by the QoS characteristics element, the QoS characteristics element includes n pieces of fourth indication information and n bandwidth fields. n is a positive integer. One piece of fourth indication information indicates a length of medium time that is required by each mean service interval for transmission on one of the n links and that is requested by the first device. In other words, the fourth indication information indicates a size of a time resource allocated to one of the n links each time. One bandwidth field indicates a maximum bandwidth for transmission on one of the n links. In other words, if n bits in the second indication information are all set to a second value (for example, 1), n pieces of fourth indication information and n bandwidth fields are required in the QoS characteristics element to indicate lengths of medium time required by each mean service interval for transmission on the n links and maximum transmission bandwidths of the n links.

The third indication information may indicate the mean service interval allocated to the first device for frame exchange on the P2P link/direct link, or indicate an average length of two consecutive service intervals allocated to the first device for frame exchange on the P2P link/direct link, or indicate an average length of service intervals. In other words, the third indication information indicates an interval at which a time resource is allocated to the first device once.

The second indication information may be a field in the QoS characteristics element, for example, an ML bitmap for P2P field or an ML bitmap for P2P link field. Certainly, the second indication information may also have another name. This is not limited in embodiments of the present disclosure. The third indication information may be a newly added field in the QoS characteristics element, for example, a mean service interval field. Certainly, the third indication information may also have another name. This is not limited in embodiments of the present disclosure. The fourth indication information may be a field in the QoS characteristics element, for example, a medium time per mean service interval for link x field. Certainly, the fourth indication information may also have another name. This is not limited in embodiments of the present disclosure.

FIG. 14b is a schematic diagram of another frame format of third indication information and another frame format of fourth indication information according to an embodiment of the present disclosure. As shown in FIG. 14b, a QoS characteristics element includes but is not limited to a control information (control info) field, a mean service interval field (namely, the foregoing third indication information), an ML bitmap for P2P link field (namely, the foregoing second indication information), and a medium time per mean service interval for link x field (namely, the foregoing fourth indication information). For a frame format of the control information field, refer to FIG. 7. The mean service interval field has a length of 4 octets and includes an unsigned integer that specifies an average length of two consecutive service intervals that are allocated to a STA for frame exchange on a P2P link/direct link. When a direction subfield in the control information field is set to 2, the ML bitmap for P2P link field is present. When the ML bitmap for P2P link field is present in the QoS characteristics element, a length of the ML bitmap for P2P link field is 1 octet or 2 octets. One bit corresponds to one link. A link ID of the link is allocated by an AP MLD associated with the link (namely, the first device). If a bit in the ML bitmap for P2P link field is set to 1, it indicates that the P2P link/direct link described by the QoS characteristics element is mapped to a link corresponding to the bit. If a bit in the ML bitmap for P2P link field is set to 0, it indicates that the P2P link/direct link described by the QoS characteristics element is not mapped to a link corresponding to the bit. When n bits in the ML bitmap for P2P link field are set to 1, the QoS characteristics element includes n medium time per mean service interval for link x fields and n bandwidth fields. n is a positive integer. One medium time per mean service interval for link x field has a length of 1 octet, namely, 8 bits, and includes an unsigned integer that specifies medium time requested by a STA for transmission on a link x as a length of medium time required by each mean service interval.

In the implementation 3.2, the P2P link/direct link is extended to MLDs, and a corresponding length indication manner for the medium time required by each mean service interval is designed, so that a time resource allocation manner can be refined, and an interval at which the AP MLD allocates a time resource to a link in the non-AP MLD once and a length of the time resource allocated each time are specified. In addition, advantages of the multi-link can be used, to improve transmission efficiency/a throughput of the P2P service and further reduce latency.

Optionally, the QoS characteristics element may further include fifth indication information, and the fifth indication information may indicate a P2P link/direct link to which a traffic flow (or a P2P service) described by the QoS characteristics element is mapped. For a specific implementation of the fifth indication information, refer to the corresponding descriptions in Embodiment 1 or corresponding descriptions in Embodiment 3. The fifth indication information may be a newly added field in the QoS characteristics element, for example, a P2P link identifier field. Certainly, the fifth indication information may also have another name. This is not limited in embodiments of the present disclosure.

Optionally, the control information field may further include a TID subfield, and a TID value indicated by the TID subfield is different from a TID value corresponding to any service on a P2P link set up between the first device and another device. In other words, when establishing a service, the first device allocates a unique TID to any service on a plurality of P2P links. Alternatively, a TID value indicated by the TID subfield is different from a TID value corresponding to a traffic flow on a P2P link that is historically reported by the first device based on the QoS characteristics element. In other words, the first device allocates a unique TID to a service that needs to be reported. A TID corresponding to a service that does not need to be reported may be reused on different P2P links.

In this embodiment, the P2P link identifier field (namely, the fifth indication information) is carried in the QoS characteristics element, to indicate the P2P link/direct link to which the traffic flow described by the QoS characteristics element is mapped, or restrict that a TID of a P2P service reported in the QoS characteristics element is unique, so that an AP side can distinguish a P2P link that a P2P traffic flow reported by a station side is for, thereby avoiding causing confusion to the AP side.
S203: A second device receives the QoS characteristics element.
S204: The second device parses the QoS characteristics element.
S205: The second device determines, based on indications of the third indication information and the fourth indication information, a time resource allocated to a service on the P2P link.

Optionally, the second device in this embodiment is an AP (single-link) or an AP MLD. After receiving the QoS characteristics element, the second device parses the QoS characteristics element to obtain the third indication information and the fourth indication information. The second device may determine, based on the indication of the third indication information, the interval at which the time resource is allocated to the first device once, and the size of the time resource allocated each time may be determined based on the fourth indication information. In other words, the second device may allocate the time resource to the first device once at intervals of a time length indicated by the third indication information, and the size of the time resource allocated each time may be a time length indicated by the fourth indication information. For example, it is assumed that the time length indicated by the third indication information is 100 ms (millisecond), and the time length indicated by the fourth indication information is 2 ms, the second device may allocate the time resource to the first device once at intervals of 100 ms, and the size of the time resource allocated each time is 2 ms.

In this embodiment, the mean service interval field is added to the QoS characteristics element, and the medium time is allocated from being based on a total time length required in each second to being based on a length of medium time required by the mean service interval. A time resource allocation manner may be refined, so as to determine an interval at which the AP allocates a time resource to the STA once and a length of a time resource allocated each time.

### Embodiment 3

Embodiment 3 of the present disclosure may be an independent embodiment, or may be implemented together with Embodiment 1 or Embodiment 2. This is not limited in the present disclosure.

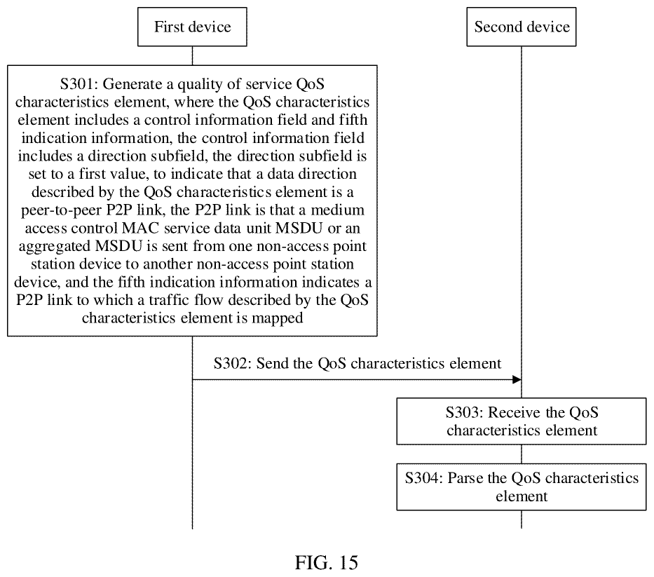

FIG. 15 is a third schematic flowchart of an information indication method for a P2P link according to an embodiment of the present disclosure. This mainly describes how a P2P link identifier is added to a QoS characteristics element to distinguish between services on different P2P links of a STA. As shown in FIG. 15, the information indication method for a P2P link includes but is not limited to the following steps.
S301: A first device generates a quality of service (QOS) characteristics element, where the QOS characteristics element includes a control information field and fifth indication information, the control information field includes a direction subfield, the direction subfield is set to a first value, to indicate that a data direction described by the QoS characteristics element is a peer-to-peer (P2P) link, the P2P link is that a medium access control (MAC) service data unit (MSDU) or an aggregated MSDU is sent from one non-access point station device to another non-access point station device, and the fifth indication information indicates a P2P link to which a traffic flow described by the QoS characteristics element is mapped.
S302: The first device sends the QoS characteristics element.

Optionally, the first device in this embodiment is a STA (single-link) or a non-AP MLD. The first device generates the QoS characteristics element. The QoS characteristics element may be carried in an SCS request frame. Certainly, the QoS characteristics element may alternatively be carried in another MAC frame. This is not limited in embodiments of the present disclosure. The first device sends the QoS characteristics element. In other words, the first device sends a frame that carries the QoS characteristics element. For example, the first device sends an SCS request frame, and the SCS request frame carries the QoS characteristics element.

The QoS characteristics element includes but is not limited to the control information (control info) field and the fifth indication information. The control information field includes but is not limited to the direction subfield. The direction subfield is set to 2 (that is, the first value is 2 in decimal system and 10 in binary system), to indicate that the data direction described by the QoS characteristics element is the P2P link/a direct link, that is, the data direction is that data (for example, an MSDU or an A-MSDU) is sent from one non-access point station device to another non-access point station device. Herein, the non-access point station device may be a STA, or may be a non-AP MLD. In other words, the data direction is that the data is sent from one STA to another STA, or the data is sent from one non-AP MLD to another non-AP MLD. The fifth indication information may indicate a P2P link/direct link to which the traffic flow described by the QoS characteristics element is mapped.

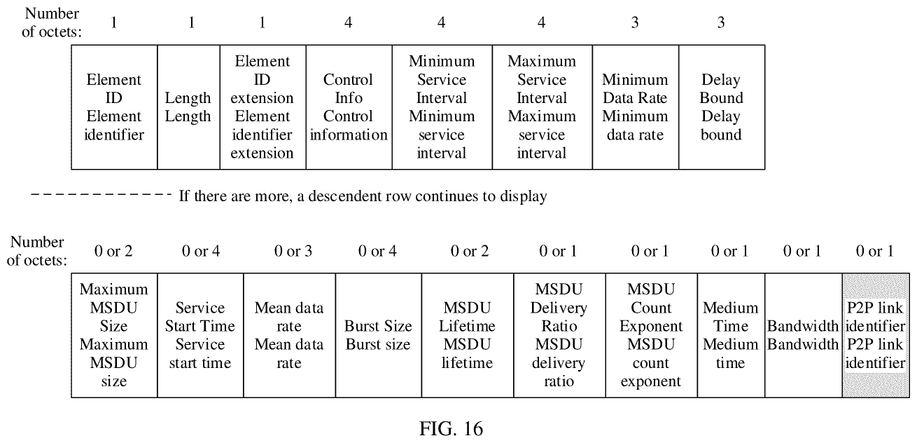

Optionally, the fifth indication information may be a newly added field in the QoS characteristics element, for example, a P2P link identifier field. Certainly, the fifth indication information may also have another name. This is not limited in embodiments of the present disclosure. FIG. 16 is a schematic diagram of a frame format of fifth indication information according to an embodiment of the present disclosure. As shown in FIG. 16, when a QoS characteristics element includes but is not limited to a control information (control info) field and a P2P link identifier field (namely, the foregoing fifth indication information), for a frame format of the control information (control info) field, refer to FIG. 7. When a direction subfield in the control information field is set to 2, the P2P link identifier field is present. The P2P link identifier field may occupy four bits in one octet (namely, eight bits), and each value corresponds to a unique P2P link. An identifier value of the P2P link may be determined by a station. To be specific, the identifier value of the P2P link is used to identify a P2P link/direct link to which a traffic flow described by the QoS characteristics element is mapped.

It should be understood that, because a station may set up P2P links/direct links with a plurality of other stations separately, when the station reports a characteristic of a P2P service to an AP associated with the station, the AP cannot learn of a P2P link that the reported service is for. In other words, it is assumed that services (actually, which are different services because they are on different P2P links) identified by a TID are established on two P2P links respectively, after the station successively reports parameters of the services identified by the same TID on the two P2P links, the AP may consider that the parameter of the service reported later is an update of the parameter of the service reported earlier, and then replace the parameter of the service reported earlier instead of considering that the parameters are from two different services and storing the parameters separately. FIG. 5a is used as an example. It is assumed that there are services identified by TIDs 0 to 3 respectively on the P2P link 1 set up between the STA 1 and the STA 2, and services identified by a TID 0 and a TID 1 on the P2P link 2 set up between the STA 1 and the STA 3. It is assumed that the STA 1 first reports a parameter of a service with a TID of 1 to the associated AP 1, and it is assumed that the service with the TID of 1 is on the P2P link 1. Then, the STA 1 reports a parameter of a service with a TID of 1 to the AP 1, and it is assumed that the service with the TID of 1 is on the P2P link 2. In this case, because the AP 1 does not learn that the two successively reported services with the TIDs of 1 are on different P2P links, the AP 1 may understand that the parameter of the service with the TID of 1 reported later is an update of the parameter of the service with the TID of 1 reported earlier, and then replace the parameter of the service with the TID of 1 reported earlier instead of understanding that the parameters are from two different services and storing the parameters separately.

Therefore, in this embodiment, the P2P link identifier field indicating the P2P link is introduced into the QoS characteristics element. In this way, even if the station successively reports services on a plurality of P2P links, and a plurality of services use a same TID, the AP may distinguish between the plurality of services based on the P2P link identifier field.

Optionally, when the first device is the non-AP MLD, the QoS characteristics element may further include second indication information. For a specific implementation of the second indication information, refer to the corresponding descriptions in Embodiment 1. If n bits in the second indication information are all set to a second value (for example, 1), that is, the second indication information indicates that n links in multiple links are used as P2P links/direct links described by the QOS characteristics element, the QOS characteristics element includes n bandwidth fields. n is a positive integer. One bandwidth field indicates a maximum bandwidth for transmission on one of the n links.

It should be understood that, when the first device is the non-AP MLD, although the P2P link is mapped to a multi-link (or the P2P service is transmitted on a multi-link), there is only one P2P link between one non-AP MLD and another non-AP MLD. Therefore, there is only one P2P link identifier field in the QoS characteristics element.
S303: A second device receives the QoS characteristics element.
S304: The second device parses the QOS characteristics element.

Optionally, the second device in this embodiment is an AP (single-link) or an AP MLD. After receiving the frame that carries the QoS characteristics element, the second device may parse the QoS characteristics element to obtain the fifth indication information. The second device may determine, based on the fifth indication information, a P2P link/direct link that the traffic flow described by the QoS characteristics element is for.

In this embodiment, the P2P link identifier field (namely, the fifth indication information) is added to the QoS characteristics element, to indicate the P2P link/direct link that the traffic flow described by the QoS characteristics element is for, so that an AP side can distinguish between P2P services reported by a station side, thereby avoiding causing confusion to the AP side.

### Embodiment 4

Embodiment 4 of the present disclosure may be an independent embodiment, or may be implemented together with Embodiment 1 or Embodiment 2. This is not limited in the present disclosure.

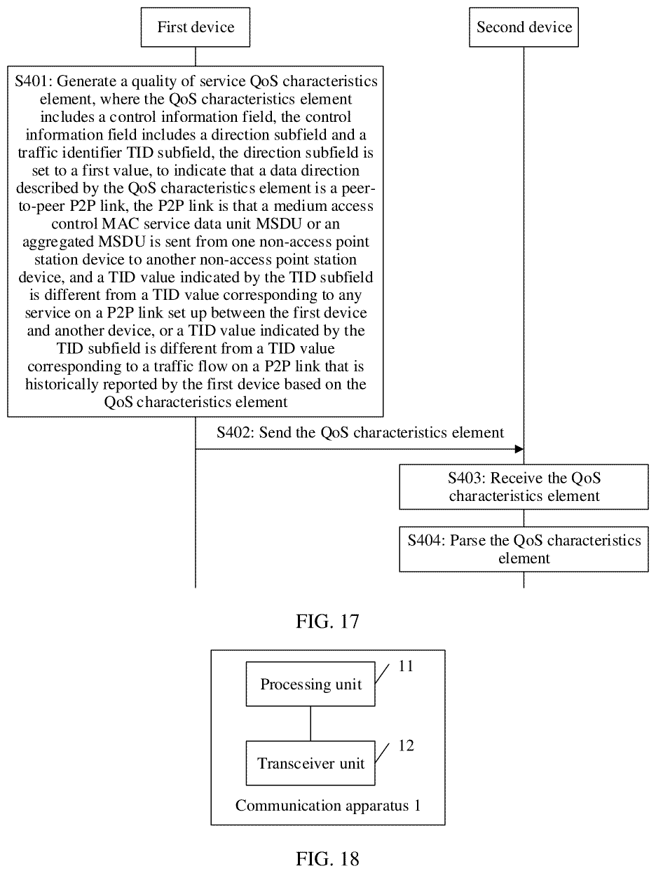

FIG. 17 is a fourth schematic flowchart of an information indication method for a P2P link according to an embodiment of the present disclosure. This mainly describes how a STA allocates a unique TID to a P2P service reported in a QoS characteristics element to prevent an AP from confusing services on different P2P links. As shown in FIG. 17, the information indication method for a P2P link includes but is not limited to the following steps.
S401: A first device generates a quality of service (QOS) characteristics element, where the QoS characteristics element includes a control information field, the control information field includes a direction subfield and a traffic identifier (TID) subfield, the direction subfield is set to a first value, to indicate that a data direction described by the QoS characteristics element is a peer-to-peer (P2P) link, the P2P link is that a medium access control (MAC) service data unit (MSDU) or an aggregated MSDU is sent from one non-access point station device to another non-access point station device, and a TID value indicated by the TID subfield is different from a TID value corresponding to any service on a P2P link set up between the first device and another device, or a TID value indicated by the TID subfield is different from a TID value corresponding to a traffic flow on a P2P link that is historically reported by the first device based on the QoS characteristics element.
S402: The first device sends the QoS characteristics element.
S403: A second device receives the QOS characteristics element.
S404: The second device parses the QoS characteristics element.

Optionally, in this embodiment, the first device is a STA (single-link) or a non-AP MLD, and the second device is an AP (single-link) or a non-AP MLD. The first device generates the QoS characteristics element. The QoS characteristics element may be carried in an SCS request frame. Certainly, the QoS characteristics element may alternatively be carried in another MAC frame. This is not limited in embodiments of the present disclosure. The first device sends the QoS characteristics element. In other words, the first device sends a frame that carries the QoS characteristics element. For example, the first device sends an SCS request frame, and the SCS request frame carries the QOS characteristics element.

The QoS characteristics element includes but is not limited to the control information (control info) field. The control information field includes but is not limited to the direction subfield and a traffic identifier (TID) subfield. The direction subfield is set to 2 (that is, the first value is 2 in decimal system and 10 in binary system), to indicate that the data direction described by the QoS characteristics element is the P2P link/a direct link, that is, the data direction is that data (for example, an MSDU or an A-MSDU) is sent from one non-access point station device to another non-access point station device. Herein, the non-access point station device may be a STA, or may be a non-AP MLD. In other words, the data direction is that the data is sent from one STA to another STA, or the data is sent from one non-AP MLD to another non-AP MLD.

The TID value indicated by the TID subfield is different from the TID value corresponding to any service on the P2P link set up between the first device and the another device. In other words, when establishing a service, the first device allocates a unique TID to any service on a plurality of P2P links. FIG. 5a is used as an example. It is assumed that the first device is the STA 1. If a TID corresponding to a service on the P2P link 1 set up between the STA 1 and the STA 2 is 0, a TID corresponding to a service on the P2P link 2 set up between the STA 1 and the STA 3 cannot be 0, but is another value, for example, 1.

Alternatively, the TID value indicated by the TID subfield is different from the TID value corresponding to the traffic flow on the P2P link that is historically reported by the first device based on the QoS characteristics element. In other words, the first device allocates a unique TID to a service that needs to be reported. A TID corresponding to a service that does not need to be reported may be reused on different P2P links. This is because a station reports only characteristics of services such as a low latency service that has specific requirements on QoS. Therefore, it is restricted that the service that needs to be reported has a unique TID, to avoid causing confusion to an AP side. FIG. 5a is used as an example. It is assumed that the first device is the STA 1. If a service on the P2P link 1 set up between the STA 1 and the STA 2 needs to be reported based on the QoS characteristics element, and a TID corresponding to the service is 0, a TID corresponding to a service that needs to be reported on the P2P link 2 set up between the STA 1 and the STA 3 cannot be 0, but is another value, for example, 1.

Optionally, when the first device is the non-AP MLD, the QoS characteristics element may further include second indication information. For a specific implementation of the second indication information, refer to the corresponding descriptions in Embodiment 1. If n bits in the second indication information are all set to a second value (for example, 1), that is, the second indication information indicates that n links in multiple links are used as P2P links/direct links described by the QOS characteristics element, the QOS characteristics element includes n bandwidth fields. n is a positive integer. One bandwidth field indicates a maximum bandwidth for transmission on one of the n links.

After receiving the frame that carries the QOS characteristics element, the second device may parse the QoS characteristics element to obtain the TID value indicated by the TID subfield, and may store a parameter (the parameter herein is carried in the QoS characteristics element) corresponding to the TID value.

In this embodiment, it is restricted that a P2P service has a unique TID, or that a P2P service that needs to be reported has a unique TID. In this way, the AP side does not receive a plurality of P2P services that have a same TID and that are reported by a same station. To be specific, when reporting P2P services, the station does not use a same TID for services on different P2P links, thereby avoiding causing confusion to the AP side.

The foregoing content describes in detail the methods provided in the present disclosure. To facilitate implementation of the foregoing solutions in embodiments of the present disclosure, embodiments of the present disclosure further provide corresponding apparatuses or devices.

In embodiments of the present disclosure, a first device and a second device may be divided into functional modules based on the foregoing method examples. For example, each functional module may be obtained through division based on each corresponding function, or two or more functions may be integrated into one processing module. The foregoing integrated module may be implemented in a form of hardware, or may be implemented in a form of a software functional module. It should be noted that, in embodiments of the present disclosure, division into modules is an example, and is merely a logical function division. During actual implementation, another division manner may be used. The following describes in detail communication apparatuses in embodiments of the present disclosure with reference to FIG. 18 to FIG. 20. The communication apparatus is a first device or a second device. Further, the communication apparatus may be an apparatus in the first device. Alternatively, the communication apparatus is an apparatus in the second device.

When an integrated unit is used, FIG. 18 is a schematic diagram of a structure of a communication apparatus 1 according to an embodiment of the present disclosure. The communication apparatus 1 may be a first device or a chip in the first device, for example, a Wi-Fi chip. As shown in FIG. 18, the communication apparatus 1 includes a processing unit 11 and a transceiver unit 12.

In an example embodiment, the processing unit 11 is configured to generate a QoS characteristics element, where the QoS characteristics element includes a control information field and first indication information, the control information field includes a direction subfield, the direction subfield is set to a first value, to indicate that a data direction described by the QoS characteristics element is a P2P link, the P2P link is that an MSDU or an aggregated MSDU is sent from one non-access point station device to another non-access point station device, and the first indication information indicates a physical layer rate of the P2P link. The transceiver unit 12 is configured to send the QoS characteristics element. The P2P link is short for data transmission on the P2P link.

Optionally, the first indication information includes one or more of the following: a physical layer rate, a modulation and coding scheme, and a number of spatial streams.

Optionally, the QOS characteristics element further includes second indication information, and the second indication information indicates that at least one of multiple links is used as the P2P link described by the QOS characteristics element. If the second indication information indicates that n links in the multiple links are used as P2P links described by the QoS characteristics element, the QoS characteristics element includes n pieces of first indication information and n bandwidth fields, and n is a positive integer. One piece of first indication information indicates a physical layer rate of one of the n links, and one bandwidth field indicates a maximum bandwidth for transmission on one of the n links.

Optionally, the second indication information is a bitmap, and one bit of the second indication information corresponds to one link. When one bit of the second indication information is set to a second value, it indicates that a link corresponding to the bit is used as the P2P link described by the QoS characteristics element.

Optionally, the QOS characteristics element further includes third indication information, and the third indication information indicates a mean service interval allocated to the first device for frame exchange on the P2P link.

Optionally, the QOS characteristics element further includes fifth indication information, and the fifth indication information indicates a P2P link to which a traffic flow described by the QoS characteristics element is mapped.

Optionally, the control information field further includes a traffic identifier (TID) subfield. A TID value indicated by the TID subfield is different from a TID value corresponding to any service on a P2P link set up between the first device and another device. Alternatively, a TID value indicated by the TID subfield is different from a TID value corresponding to a traffic flow on a P2P link that is historically reported by the first device based on the QoS characteristics element.

It should be understood that the communication apparatus in this design may correspondingly perform Embodiment 1, and the foregoing operations or functions of the units in the communication apparatus are used to implement corresponding operations of the first device in Embodiment 1 respectively.

In an example embodiment, the processing unit 11 is configured to generate a QoS characteristics element, where the QoS characteristics element includes a control information field, third indication information, and fourth indication information, the control information field includes a direction subfield, the direction subfield is set to a first value, to indicate that a data direction described by the QoS characteristics element is a P2P link, the P2P link is that an MSDU or an aggregated MSDU is sent from one non-access point station device to another non-access point station device, the third indication information indicates a mean service interval allocated to the first device for frame exchange on the P2P link, and the fourth indication information indicates medium time that is required by each mean service interval for transmission on the P2P link and that is requested by the first device. The transceiver unit 12 is configured to send the QoS characteristics element. The P2P link is short for data transmission on the P2P link.

Optionally, the QOS characteristics element further includes second indication information, and the second indication information indicates that at least one of multiple links is used as the P2P link described by the QOS characteristics element. If the second indication information indicates that n links in the multiple links are used as P2P links described by the QoS characteristics element, the QoS characteristics element includes n pieces of fourth indication information and n bandwidth fields, and n is a positive integer. One piece of fourth indication information indicates medium time that is required by each mean service interval for transmission on one of the n links and that is requested by the first device, and one bandwidth field indicates a maximum bandwidth for transmission on one of the n links.

Optionally, the second indication information is a bitmap, and one bit of the second indication information corresponds to one link. When one bit of the second indication information is set to a second value, it indicates that a link corresponding to the bit is used as the P2P link described by the QoS characteristics element.

Optionally, the QOS characteristics element further includes fifth indication information, and the fifth indication information indicates a P2P link to which a traffic flow described by the QoS characteristics element is mapped.

Optionally, the control information field further includes a traffic identifier (TID) subfield. A TID value indicated by the TID subfield is different from a TID value corresponding to any service on a P2P link set up between the first device and another device. Alternatively, a TID value indicated by the TID subfield is different from a TID value corresponding to a traffic flow on a P2P link that is historically reported by the first device based on the QoS characteristics element.

It should be understood that the communication apparatus in this embodiment may correspondingly perform Embodiment 2, and the foregoing operations or functions of the units in the communication apparatus are used to implement corresponding operations of the first device in Embodiment 2 respectively.

In an example embodiment, the processing unit 11 is configured to generate a QoS characteristics element, where the QoS characteristics element includes a control information field and fifth indication information, the control information field includes a direction subfield, the direction subfield is set to a first value, to indicate that a data direction described by the QoS characteristics element is a P2P link, the P2P link is that an MSDU or an aggregated MSDU is sent from one non-access point station device to another non-access point station device, and the fifth indication information indicates a P2P link to which a traffic flow described by the QoS characteristics element is mapped. The transceiver unit 12 is configured to send the QoS characteristics element.

Optionally, the QOS characteristics element further includes second indication information, and the second indication information indicates that at least one of multiple links is used as the P2P link described by the QoS characteristics element. If the second indication information indicates that n links in the multiple links are used as P2P links described by the QoS characteristics element, the QoS characteristics element includes n bandwidth fields, and n is a positive integer. One bandwidth field indicates a maximum bandwidth for transmission on one of the n links.

Optionally, the second indication information is a bitmap, and one bit of the second indication information corresponds to one link. When one bit of the second indication information is set to a second value, it indicates that a link corresponding to the bit is used as the P2P link described by the QoS characteristics element.

It should be understood that the communication apparatus in this embodiment may correspondingly perform Embodiment 3, and the foregoing operations or functions of the units in the communication apparatus are used to implement corresponding operations of the first device in Embodiment 3 respectively.

In an example embodiment, the processing unit 11 is configured to generate a QoS characteristics element, where the QoS characteristics element includes a control information field, the control information field includes a direction subfield and a traffic identifier (TID) subfield, the direction subfield is set to a first value, to indicate that a data direction described by the QoS characteristics element is a P2P link, the P2P link is that an MSDU or an aggregated MSDU is sent from one non-access point station device to another non-access point station device, and a TID value indicated by the TID subfield is different from a TID value corresponding to any service on a P2P link set up between the first device and another device, or a TID value indicated by the TID subfield is different from a TID value corresponding to a traffic flow on a P2P link that is historically reported by the first device based on the QoS characteristics element. The transceiver unit 12 is configured to send the QoS characteristics element.

It should be understood that the communication apparatus in this embodiment may correspondingly perform Embodiment 4, and the foregoing operations or functions of the units in the communication apparatus are used to implement corresponding operations of the first device in Embodiment 4 respectively.

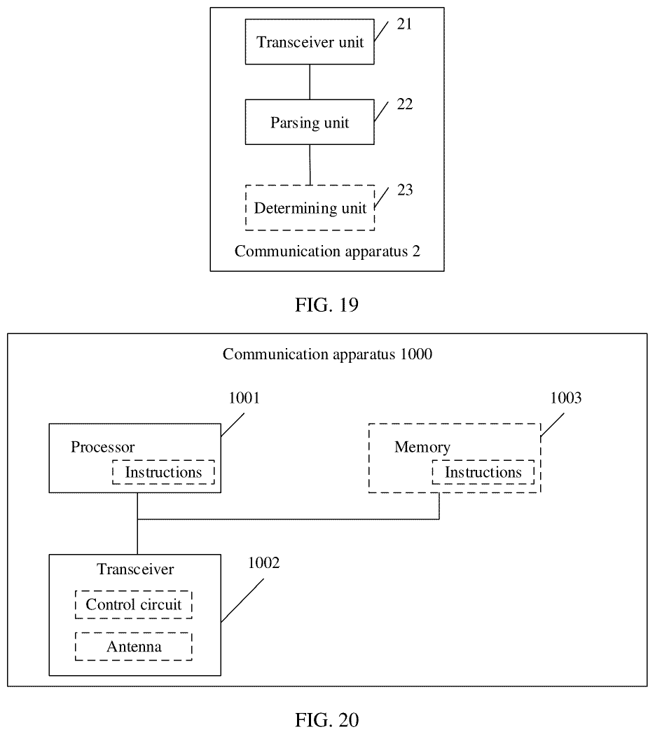

FIG. 19 is a schematic diagram of a structure of a communication apparatus 2 according to an embodiment of the present disclosure. The communication apparatus 2 may be a second device or a chip in the second device, for example, a Wi-Fi chip. As shown in FIG. 19, the communication apparatus 2 includes a transceiver unit 21 and a parsing unit 22.

In an example embodiment, the transceiver unit 21 is configured to receive a QoS characteristics element. The parsing unit 22 is configured to parse the QoS characteristics element, where the QoS characteristics element includes a control information field and first indication information, the control information field includes a direction subfield, the direction subfield is set to a first value, to indicate that a data direction described by the QoS characteristics element is a P2P link, the P2P link is that an MSDU or an aggregated MSDU is sent from one non-access point station device to another non-access point station device, and the first indication information indicates a physical layer rate of the P2P link.

Optionally, the first indication information includes one or more of the following: a physical layer rate, a modulation and coding scheme, and a number of spatial streams.

Optionally, the communication apparatus 2 further includes a determining unit 23, configured to determine, based on an indication of the first indication information, a time resource allocated to a service on the P2P link.

Optionally, the QOS characteristics element further includes second indication information, and the second indication information indicates that at least one of multiple links is used as the P2P link described by the QOS characteristics element. If the second indication information indicates that n links in the multiple links are used as P2P links described by the QoS characteristics element, the QoS characteristics element includes n pieces of first indication information and n bandwidth fields, and n is a positive integer. One piece of first indication information indicates a physical layer rate of one of the n links, and one bandwidth field indicates a maximum bandwidth for transmission on one of the n links.

Optionally, the second indication information is a bitmap, and one bit of the second indication information corresponds to one link. When one bit of the second indication information is set to a second value, it indicates that a link corresponding to the bit is used as the P2P link described by the QoS characteristics element.

Optionally, the QOS characteristics element further includes third indication information, and the third indication information indicates a mean service interval allocated to a first device for frame exchange on the P2P link.

Optionally, the QOS characteristics element further includes fifth indication information, and the fifth indication information indicates a P2P link to which a traffic flow described by the QoS characteristics element is mapped.

Optionally, the control information field further includes a traffic identifier (TID) subfield. A TID value indicated by the TID subfield is different from a TID value corresponding to any service on a P2P link set up between the first device and another device. Alternatively, a TID value indicated by the TID subfield is different from a TID value corresponding to a traffic flow on a P2P link that is historically reported by the first device based on the QoS characteristics element.

The parsing unit 22 and the determining unit 23 may be integrated into one unit, for example, a processing unit.

It should be understood that the communication apparatus in this embodiment may correspondingly perform Embodiment 1, and the foregoing operations or functions of the units in the communication apparatus are used to implement corresponding operations of the second device in Embodiment 1 respectively.

In an example embodiment, the transceiver unit 21 is configured to receive a Qos characteristics element. The parsing unit 22 is configured to parse the QoS characteristics element, where the QoS characteristics element includes a control information field, third indication information, and fourth indication information, the control information field includes a direction subfield, the direction subfield is set to a first value, to indicate that a data direction described by the QoS characteristics element is a P2P link, the P2P link is that an MSDU or an aggregated MSDU sent from one non-access point station device to another non-access point station device, the third indication information indicates a mean service interval allocated to a first device for frame exchange on the P2P link, and the fourth indication information indicates medium time that is required by each mean service interval for transmission on the P2P link and that is requested by the first device.

Optionally, the communication apparatus 2 further includes a determining unit 23, configured to determine, based on indications of the third indication information and the fourth indication information, a time resource allocated to a service on the P2P link.

Optionally, the QOS characteristics element further includes second indication information, and the second indication information indicates that at least one of multiple links is used as the P2P link described by the QOS characteristics element. If the second indication information indicates that n links in the multiple links are used as P2P links described by the QoS characteristics element, the QoS characteristics element includes n pieces of fourth indication information and n bandwidth fields, and n is a positive integer. One piece of fourth indication information indicates medium time that is required by each mean service interval for transmission on one of the n links and that is requested by the first device, and one bandwidth field indicates a maximum bandwidth for transmission on one of the n links.

Optionally, the second indication information is a bitmap, and one bit of the second indication information corresponds to one link. When one bit of the second indication information is set to a second value, it indicates that a link corresponding to the bit is used as the P2P link described by the QoS characteristics element.

Optionally, the QOS characteristics element further includes fifth indication information, and the fifth indication information indicates a P2P link to which a traffic flow described by the QoS characteristics element is mapped.

Optionally, the control information field further includes a traffic identifier (TID) subfield. A TID value indicated by the TID subfield is different from a TID value corresponding to any service on a P2P link set up between the first device and another device. Alternatively, a TID value indicated by the TID subfield is different from a TID value corresponding to a traffic flow on a P2P link that is historically reported by the first device based on the QoS characteristics element.

The parsing unit 22 and the determining unit 23 may be integrated into one unit, for example, a processing unit.

It should be understood that the communication apparatus in this embodiment may correspondingly perform Embodiment 2, and the foregoing operations or functions of the units in the communication apparatus are used to implement corresponding operations of the second device in Embodiment 2 respectively.

In an example embodiment, the transceiver unit 21 is configured to receive a QoS characteristics element. The parsing unit 22 is configured to parse the QoS characteristics element, where the QoS characteristics element includes a control information field and fifth indication information, the control information field includes a direction subfield, the direction subfield is set to a first value, to indicate that a data direction described by the QoS characteristics element is a P2P link, the P2P link is that an MSDU or an aggregated MSDU is sent from one non-access point station device to another non-access point station device, and the fifth indication information indicates a P2P link to which a traffic flow described by the QoS characteristics element is mapped.

Optionally, the QOS characteristics element further includes second indication information, and the second indication information indicates that at least one of multiple links is used as the P2P link described by the QoS characteristics element. If the second indication information indicates that n links in the multiple links are used as P2P links described by the QoS characteristics element, the QoS characteristics element includes n bandwidth fields, and n is a positive integer. One bandwidth field indicates a maximum bandwidth for transmission on one of the n links.

Optionally, the second indication information is a bitmap, and one bit of the second indication information corresponds to one link. When one bit of the second indication information is set to a second value, it indicates that a link corresponding to the bit is used as the P2P link described by the QoS characteristics element.

The parsing unit 22 may also be referred to as a processing unit.

It should be understood that the communication apparatus in this embodiment may correspondingly perform Embodiment 3, and the foregoing operations or functions of the units in the communication apparatus are used to implement corresponding operations of the second device in Embodiment 3 respectively.

In an example embodiment, the transceiver unit 21 is configured to receive a QoS characteristics element. The parsing unit 22 is configured to parse the QoS characteristics element, where the QoS characteristics element includes a control information field, the control information field includes a direction subfield and a traffic identifier (TID) subfield, the direction subfield is set to a first value, to indicate that a data direction described by the QoS characteristics element is a P2P link, the P2P link is that an MSDU or an aggregated MSDU is sent from one non-access point station device to another non-access point station device, and a TID value indicated by the TID subfield is different from a TID value corresponding to any service on a P2P link set up between a first device and another device, or a TID value indicated by the TID subfield is different from a TID value corresponding to a traffic flow on a P2P link that is historically reported by a first device based on the QOS characteristics element.

The parsing unit 22 may also be referred to as a processing unit.

It should be understood that the communication apparatus in this embodiment may correspondingly perform Embodiment 4, and the foregoing operations or functions of the units in the communication apparatus are used to implement corresponding operations of the second device in Embodiment 4 respectively.

The foregoing describes the first device and the second device in embodiments of the present disclosure. The following describes possible product forms of the first device and the second device. It should be understood that any product in any form that has the function of the first device in FIG. 18 and any product in any form that has the function of the second device in FIG. 19 fall within the protection scope of embodiments of the present disclosure. It should be further understood that the following descriptions are merely examples, and the product forms of the first device and the second device in embodiments of the present disclosure are not limited thereto.

In a possible product form, the AP MLD and the non-AP MLD described in embodiments of the present disclosure may be implemented through a general bus architecture.

For ease of description, FIG. 20 is a schematic diagram of a structure of a communication apparatus 1000 according to an embodiment of the present disclosure. The communication apparatus 1000 may be a first device, a second device, or a chip in the first device or the second device. FIG. 20 shows only main components of the communication apparatus 1000. In addition to a processor 1001 and a transceiver 1002, the communication apparatus may further include a memory 1003 and an input/output apparatus (not shown in the figure).

The processor 1001 is mainly configured to process a communication protocol and communication data, control the entire communication apparatus, execute a software program, and process data of the software program. The memory 1003 is mainly configured to store the software program and the data. The transceiver 1002 may include a control circuit and an antenna. The control circuit is mainly configured to perform conversion between a baseband signal and a radio frequency signal and process the radio frequency signal. The antenna is mainly configured to receive/send a radio frequency signal in a form of an electromagnetic wave. The input/output apparatus, such as a touchscreen, a display screen, or a keyboard, is mainly configured to: receive data input by a user and output data to the user.

After the communication apparatus is powered on, the processor 1001 may read the software program from the memory 1003, interpret and execute instructions of the software program, and process data of the software program. When data needs to be sent in a wireless manner, the processor 1001 performs baseband processing on the to-be-sent data, and then outputs a baseband signal to a radio frequency circuit. The radio frequency circuit performs radio frequency processing on the baseband signal, and then sends a radio frequency signal in an electromagnetic wave form through the antenna. When data is sent to the communication apparatus, the radio frequency circuit receives a radio frequency signal through the antenna, converts the radio frequency signal into a baseband signal, and outputs the baseband signal to the processor 1001. The processor 1001 converts the baseband signal into data, and processes the data.

In another implementation, the radio frequency circuit and the antenna may be disposed independent of the processor that performs baseband processing. For example, in a distributed scenario, the radio frequency circuit and the antenna may be remotely disposed independent of the communication apparatus.

The processor 1001, the transceiver 1002, and the memory 1003 may be connected through a communication bus.

In an example embodiment, the communication apparatus 1000 may be configured to perform a function of the first device in Embodiment 1. The processor 1001 may be configured to perform step S101 in FIG. 8, and/or another process of the technology described in this specification. The transceiver 1002 may be configured to perform step S102 in FIG. 8, and/or used in another process of the technology described in this specification.

In another example embodiment, the communication apparatus 1000 may be configured to perform a function of the second device in Embodiment 1. The processor 1001 may be configured to perform step S104 and step S105 in FIG. 8, and/or another process of the technology described in this specification. The transceiver 1002 may be configured to perform step S103 in FIG. 8, and/or used in another process of the technology described in this specification.

In an example embodiment, the communication apparatus 1000 may be configured to perform a function of the first device in Embodiment 2. The processor 1001 may be configured to perform step S201 in FIG. 13, and/or another process of the technology described in this specification. The transceiver 1002 may be configured to perform step S202 in FIG. 13, and/or used in another process of the technology described in this specification.

In another example embodiment, the communication apparatus 1000 may be configured to perform a function of the second device in Embodiment 2. The processor 1001 may be configured to perform step S204 and step S205 in FIG. 13, and/or another process of the technology described in this specification. The transceiver 1002 may be configured to perform step S203 in FIG. 13, and/or used in another process of the technology described in this specification.

In an example embodiment, the communication apparatus 1000 may be configured to perform a function of the first device in Embodiment 3. The processor 1001 may be configured to perform step S301 in FIG. 15, and/or another process of the technology described in this specification. The transceiver 1002 may be configured to perform step S302 in FIG. 15, and/or used in another process of the technology described in this specification.

In another example embodiment, the communication apparatus 1000 may be configured to perform a function of the second device in Embodiment 3. The processor 1001 may be configured to perform step S304 in FIG. 15, and/or another process of the technology described in this specification. The transceiver 1002 may be configured to perform step S303 in FIG. 15, and/or used in another process of the technology described in this specification.

In an example embodiment, the communication apparatus 1000 may be configured to perform a function of the first device in Embodiment 4. The processor 1001 may be configured to perform step S401 in FIG. 17, and/or another process of the technology described in this specification. The transceiver 1002 may be configured to perform step S402 in FIG. 17, and/or used in another process of the technology described in this specification.

In another example embodiment, the communication apparatus 1000 may be configured to perform a function of the second device in Embodiment 4. The processor 1001 may be configured to perform step S404 in FIG. 17, and/or another process of the technology described in this specification. The transceiver 1002 may be configured to perform step S403 in FIG. 17, and/or used in another process of the technology described in this specification.

In any one of the foregoing embodiments, the processor 1001 may include a transceiver configured to implement a receiving function and a sending function. For example, the transceiver may be a transceiver circuit, an interface, or an interface circuit. The transceiver circuit, the interface, or the interface circuit configured to implement the receiving and sending functions may be separated, or may be integrated together. The transceiver circuit, the interface, or the interface circuit may be configured to read or write code/data; or the transceiver circuit, the interface, or the interface circuit may be configured to perform signal transmission or transferring.

In any one of the foregoing embodiments, the processor 1001 may store instructions. The instructions may be a computer program. The computer program is run on the processor 1001, so that the communication apparatus 1000 can perform the method described in any one of the foregoing method embodiments. The computer program may be fixed in the processor 1001, and in this case, the processor 1001 may be implemented by hardware.

In an implementation, the communication apparatus 1000 may include a circuit, and the circuit may implement a sending, receiving, or communication function in the foregoing method embodiments. The processor and the transceiver described in the present disclosure may be implemented on an integrated circuit (IC), an analog IC, a radio frequency integrated circuit (RFIC), a mixed-signal IC, an application-specific integrated circuit (ASIC), a printed circuit board (PCB), an electronic device, or the like. The processor and the transceiver may alternatively be manufactured by using various IC technologies, for example, a complementary metal-oxide-semiconductor (CMOS), an n-type metal oxide semiconductor (nMetal-oxide-semiconductor, NMOS), a p-type metal oxide semiconductor (positive channel metal oxide semiconductor, PMOS), a bipolar junction transistor (BJT), a bipolar CMOS (BiCMOS), silicon germanium (SiGe), and gallium arsenide (GaAs).

A scope of the communication apparatus described in the present disclosure is not limited thereto, and a structure of the communication apparatus may not be limited in FIG. 20. The communication apparatus may be an independent device or may be a part of a large device. For example, the communication apparatus may be:
(1) an independent integrated circuit IC, a chip, or a chip system or subsystem;
(2) a set including one or more ICs, where optionally, the set of ICs may also include a storage component configured to store data and a computer program;
(3) an ASIC, for example, a modem;
(4) a module that may be embedded in another device;
(5) a receiver, a terminal, an intelligent terminal, a cellular phone, a wireless device, a handheld device, a mobile unit, a vehicle-mounted device, a network device, a cloud device, an artificial intelligence device, or the like; or
(6) another device, or the like.

In a possible product form, the first device and the second device in embodiments of the present disclosure may be implemented via general-purpose processors.

The general-purpose processor for implementing the first device includes a processing circuit and an input/output interface that is internally connected to and communicates with the processing circuit.

In an example embodiment, the general-purpose processor may be configured to perform a function of the first device in Embodiment 1. Specifically, the processing circuit may be configured to perform step S101 in FIG. 8, and/or another process of the technology described in this specification. The input/output interface may be configured to perform step S102 in FIG. 8, and/or another process of the technology described in this specification.

In an example embodiment, the general-purpose processor may be configured to perform a function of the first device in Embodiment 2. Specifically, the processing circuit may be configured to perform step S201 in FIG. 13, and/or another process of the technology described in this specification. The input/output interface may be configured to perform step S202 in FIG. 13, and/or used in another process of the technology described in this specification.

In an example embodiment, the general-purpose processor may be configured to perform a function of the first device in Embodiment 3. Specifically, the processing circuit may be configured to perform step S301 in FIG. 15, and/or another process of the technology described in this specification. The input/output interface may be configured to perform step S302 in FIG. 15, and/or used in another process of the technology described in this specification.

In an example embodiment, the general-purpose processor may be configured to perform a function of the first device in Embodiment 4. Specifically, the processing circuit may be configured to perform step S401 in FIG. 17, and/or another process of the technology described in this specification. The input/output interface may be configured to perform step S402 in FIG. 17, and/or used in another process of the technology described in this specification.

The general-purpose processor for implementing the second device includes a processing circuit and an input/output interface that is internally connected to and communicates with the processing circuit.

In an example embodiment, the general-purpose processor may be configured to perform a function of the second device in Embodiment 1. Specifically, the processing circuit may be configured to perform step S104 and step S105 in FIG. 8, and/or another process of the technology described in this specification. The input/output interface may be configured to perform step S103 in FIG. 8, and/or used in another process of the technology described in this specification.

In an example embodiment, the general-purpose processor may be configured to perform a function of the second device in Embodiment 2. Specifically, the processing circuit may be configured to perform step S204 and step S205 in FIG. 13, and/or another process of the technology described in this specification. The input/output interface may be configured to perform step S203 in FIG. 13, and/or used in another process of the technology described in this specification.

In an example embodiment, the general-purpose processor may be configured to perform a function of the second device in Embodiment 3. Specifically, the processing circuit may be configured to perform step S304 in FIG. 15, and/or another process of the technology described in this specification. The input/output interface may be configured to perform step S303 in FIG. 15, and/or used in another process of the technology described in this specification.

In an example embodiment, the general-purpose processor may be configured to perform a function of the second device in Embodiment 4. Specifically, the processing circuit may be configured to perform step S404 in FIG. 17, and/or another process of the technology described in this specification. The input/output interface may be configured to perform step S403 in FIG. 17, and/or used in another process of the technology described in this specification.

It should be understood that the foregoing communication apparatuses in various product forms have any function of the first device or the second device in the foregoing method embodiments.

An embodiment of the present disclosure further provides a computer-readable storage medium. The computer-readable storage medium stores computer program code. When the foregoing processor executes the computer program code, an electronic device performs the method in any one of the foregoing embodiments.

An embodiment of the present disclosure further provides a computer program product. When the computer program product runs on a computer, the computer performs the method in any one of the foregoing embodiments.

An embodiment of the present disclosure further provides a communication apparatus. The apparatus may exist in a product form of a chip. A structure of the apparatus includes a processor and an interface circuit. The processor is configured to communicate with another apparatus through the interface circuit, so that the apparatus performs the method in any one of the foregoing embodiments.

An embodiment of the present disclosure further provides a wireless communication system, including a first device and a second device. The first device and the second device may perform the method in any one of the foregoing embodiments.

Method or algorithm steps described in combination with the content disclosed in the present disclosure may be implemented by hardware, or may be implemented by a processor by executing software instructions. The software instructions may include a corresponding software module. The software module may be stored in a random access memory (RAM), a flash memory, an erasable programmable read-only memory (Erasable Programmable ROM, EPROM), an electrically erasable programmable read-only memory (Electrically EPROM, EEPROM), a register, a hard disk, a removable hard disk, a compact disc read-only memory (CD-ROM), or any other form of storage medium well-known in the art. For example, a storage medium is coupled to a processor, so that the processor can read information from the storage medium and write information into the storage medium. Certainly, the storage medium may alternatively be a component of the processor. The processor and the storage medium may be disposed in an ASIC. In addition, the ASIC may be located in a core network interface device. Certainly, the processor and the storage medium may exist in the core network interface device as discrete components.

A person skilled in the art should be aware that, in the foregoing one or more examples, the functions described in the present disclosure may be implemented by using hardware, software, firmware, or any combination thereof. When the functions are implemented by using software, the functions may be stored in a computer-readable medium or transmitted as one or more instructions or code in a computer-readable medium. The computer-readable medium includes a computer-readable storage medium and a communication medium, where the communication medium includes any medium that enables a computer program to be transmitted from one place to another place. The storage medium may be any available medium that can be accessed by a general-purpose or dedicated computer.

In the foregoing specific implementations, the objectives, technical solutions, and beneficial effects of the present disclosure are further described in detail. It should be understood that the foregoing descriptions are merely specific implementations of the present disclosure, but are not intended to limit the protection scope of the present disclosure. Any modification, equivalent replacement, improvement, or the like made based on the technical solutions of the present disclosure shall fall within the protection scope of the present disclosure.

We claim:

1. An information indication method for a peer-to-peer link, comprising:
generating, by a first device, a quality of service (Qos) characteristics element, wherein the QOS characteristics element comprises a control information field and first indication information, the control information field comprises a direction subfield, the direction subfield is set to a first value indicating that a data direction described by the QoS characteristics element is a peer-to-peer (P2P link), the P2P link is a link via which a medium access control (MAC) service data unit (MSDU) or an aggregated MSDU is sent from one non-access point station device to another non-access point station device, and the first indication information indicates a physical layer rate of the P2P link; and
sending, by the first device, the QoS characteristics element to a second device.

2. The method according to claim 1, wherein the first indication information comprises: a physical layer rate, a modulation and coding scheme, and/or a number of spatial streams.

3. The method according to claim 1, wherein the QoS characteristics element further comprises second indication information indicating that at least one of multiple links is used as the P2P link described by the QoS characteristics element;
when the second indication information indicates that n links in the multiple links are used as P2P links described by the QoS characteristics element, the QoS characteristics element comprises n pieces of first indication information and n bandwidth fields, and n is a positive integer; and
one piece of first indication information indicates a physical layer rate of one of the n links, and one bandwidth field indicates a maximum bandwidth for transmission on one of the n links.

4. The method according to claim 3, wherein the second indication information is a bitmap, and one bit of the second indication information corresponds to one link; and
when one bit of the second indication information is set to a second value indicating that a link corresponding to the bit is used as the P2P link described by the QoS characteristics element.

5. The method according to claim 1, wherein the QoS characteristics element further comprises third indication information indicating a mean service interval allocated to the first device for frame exchange on the P2P link.

6. The method according to claim 1, wherein the QoS characteristics element further comprises fifth indication information indicating a P2P link to which a traffic flow described by the QoS characteristics element is mapped.

7. The method according to claim 1, wherein the control information field further comprises a traffic identifier (TID) subfield; and
a TID value indicated by the TID subfield is different from a TID value corresponding to any service on a P2P link set up between the first device and another device; or a TID value indicated by the TID subfield is different from a TID value corresponding to a traffic flow on a P2P link that is historically reported by the first device based on the QoS characteristics element.

8. A communication apparatus, comprising:
at least one processor, configured to generate a quality of service (QOS) characteristics element, wherein the QoS characteristics element comprises a control information field and first indication information, the control information field comprises a direction subfield, the direction subfield is set to a first value indicating that a data direction described by the QoS characteristics element is a peer-to-peer (P2P) link, the P2P link is a link via which a medium access control (MAC) service data unit (MSDU) or an aggregated MSDU is sent from one non-access point station device to another non-access point station device, and the first indication information indicates a physical layer rate of the P2P link; and
a transceiver, configured to send the QoS characteristics element to another device.

9. The communication apparatus according to claim 8, wherein the at least one processor is further configured to determine, based on an indication of the first indication information, a time resource allocated to a service on the P2P link.

10. The communication apparatus according to claim 8, wherein the first indication information comprises: a physical layer rate, a modulation and coding scheme, and/or a number of spatial streams.

11. The communication apparatus according to claim 8, wherein the QoS characteristics element further comprises second indication information indicating that at least one of multiple links is used as the P2P link described by the QoS characteristics element;
when the second indication information indicates that n links in the multiple links are used as P2P links described by the QoS characteristics element, the QoS characteristics element comprises n pieces of first indication information and n bandwidth fields, and n is a positive integer; and
one piece of first indication information indicates a physical layer rate of one of the n links, and one bandwidth field indicates a maximum bandwidth for transmission on one of the n links.

12. The communication apparatus according to claim 11, wherein the second indication information is a bitmap, and one bit of the second indication information corresponds to one link; and
when one bit of the second indication information is set to a second value indicating that a link corresponding to the bit is used as the P2P link described by the QoS characteristics element.

13. The communication apparatus according to claim 8, wherein the QoS characteristics element further comprises third indication information indicating a mean service interval allocated to the communication apparatus for frame exchange on the P2P link.

14. The communication apparatus according to claim 8, wherein the QoS characteristics element further comprises fifth indication information indicating a P2P link to which a traffic flow described by the QoS characteristics element is mapped.

15. The communication apparatus according to claim 8, wherein the control information field further comprises a traffic identifier (TID) subfield; and
a TID value indicated by the TID subfield is different from a TID value corresponding to any service on a P2P link set up between the communication apparatus and another device; or a TID value indicated by the TID subfield is different from a TID value corresponding to a traffic flow on a P2P link that is historically reported by the communication apparatus based on the QoS characteristics element.

16. A communication apparatus, comprising at least one processor and a transceiver, wherein the transceiver is configured to receive/send a QoS characteristics element, and when the at least one processor runs program instructions, the communication apparatus is enabled to perform operations comprising:
receiving, a quality of service (QOS) characteristics element; and
parsing, the QoS characteristics element, wherein the QoS characteristics element comprises a control information field and first indication information, the control information field comprises a direction subfield, the direction subfield is set to a first value indicating that a data direction described by the QoS characteristics element is a peer-to-peer (P2P) link, the P2P link is a link via which a medium access control (MAC) service data unit (MSDU) or an aggregated MSDU is sent from one non-access point station device to another non-access point station device, and the first indication information indicates a physical layer rate of the P2P link.

17. The communication apparatus according to claim 16, wherein the operations further comprise:
determining, based on the first indication information, a time resource allocated to a service on the P2P link.
